(19) United States
(12) Patent Application Publication
(10) Pub. No.: US 2021/0377571 A1
(43) Pub. Date: Dec. 2, 2021

(54) SYSTEMS AND METHODS FOR SIGNALING POSITION INFORMATION

(71) Applicant: Sharp Kabushiki Kaisha, Sakai City, Osaka (JP)

(72) Inventor: Sachin G. DESHPANDE, Vancouver, WA (US)

(21) Appl. No.: 16/963,267

(22) PCT Filed: Jan. 22, 2019
(86) PCT No.: PCT/JP2019/001895

§ 371 Date: Jul. 20, 2020

Related U.S. Application Data
(60) Provisional application No. 62/622,701, filed on Jan. 26, 2018.
(60) Provisional application No. 62/655,156, filed on Apr. 9, 2018.
(60) Provisional application No. 62/669,828, filed on May 10, 2018.
(60) Provisional application No. 62/697,240, filed on Jul. 12, 2018.
(60) Provisional application No. 62/725,145, filed on Aug. 30, 2018.

(51) Int. Cl. H04N 19/70; H04N 21/81; H04N 19/597; H04N 19/174

(52) U.S. Cl. CPC H04N 19/70; H04N 19/174; H04N 19/597; H04N 21/816

(57) ABSTRACT

Following two flags [1] and [2] are signaled and parsed to transmit information associated with an omnidirectional video. (See paragraphs [0112] and [0116]-[0119].) [1] vr_space_exclusion_info_present_flag indicating that an immersive virtual reality space includes excluded areas. [2] static_vr_exclusions_flag specifying whether excluded areas are static.

### TECHNICAL FIELD

This disclosure relates to the field of interactive video distribution and more particularly to techniques for signaling of position information in a virtual reality application.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packetswitched networks, including bidirectional networks, such as Internet Protocol (IP) networks and unidirectional networks, such as digital broadcast networks.

Digital video included in digital media content may be coded according to a video coding standard. Video coding standards may incorporate video compression techniques. Examples of video coding standards include ISO/JEC MPEG-4 Visual and ITU-T H.264 (also known as ISO/JEC MPEG-4 AVC) and High-Efficiency Video Coding (HEVC). Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Prediction coding techniques may be used to generate difference values between a unit of video data to be coded and a reference unit of video data. The difference values may be referred to as residual data. Residual data may be coded as quantized transform coefficients. Syntax elements may relate residual data and a reference coding unit. Residual data and syntax elements may be included in a compliant bitstream. Compliant bitstreams and associated metadata may be formatted according to data structures. Compliant bitstreams and associated metadata may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards.

### SUMMARY OF INVENTION

In one example, a method of signaling information associated with an omnidirectional video comprises signaling a flag indicating that an immersive virtual reality space includes excluded areas and signaling information specifying the excluded areas.

In one example, a method of determining information associated with an omnidirectional video comprises parsing a flag indicating that an immersive virtual reality space includes excluded areas and parsing information to determine the excluded areas.

### BRIEF DESCRIPTION OF DRAWINGS

FIG. 1 is a block diagram illustrating an example of a system that may be configured to transmit coded video data according to one or more techniques of this this disclosure.

FIG. 2A is a conceptual diagrams illustrating coded video data and corresponding data structures according to one or more techniques of this this disclosure.

FIG. 2B is a conceptual diagrams illustrating coded video data and corresponding data structures according to one or more techniques of this this disclosure.

FIG. 3 is a conceptual diagram illustrating coded video data and corresponding data structures according to one or more techniques of this this disclosure.

FIG. 4 is a conceptual diagram illustrating an example of a coordinate system according to one or more techniques of this disclosure.

FIG. 5A is conceptual diagrams illustrating examples of specifying regions on a sphere according to one or more techniques of this this disclosure.

FIG. 5B is conceptual diagrams illustrating examples of specifying regions on a sphere according to one or more techniques of this this disclosure.

FIG. 6 is a conceptual diagrams illustrating examples of a projected picture region and a packed picture region according to one or more techniques of this disclosure.

FIG. 7 is a conceptual drawing illustrating an example of components that may be included in an implementation of a system that may be configured to transmit coded video data according to one or more techniques of this this disclosure.

FIG. 8 is a block diagram illustrating an example of a data encapsulator that may implement one or more techniques of this disclosure.

FIG. 9 is a block diagram illustrating an example of a receiver device that may implement one or more techniques of this disclosure.

FIG. 10 is a conceptual drawing illustrating examples of processing stages to derive a packed picture from a spherical image or vice versa.

### DESCRIPTION OF EMBODIMENTS

In general, this disclosure describes various techniques for signaling information associated with a virtual reality application. In particular, this disclosure describes techniques for signaling position information. It should be noted that although in some examples, the techniques of this disclosure are described with respect to transmission standards, the techniques described herein may be generally applicable. For example, the techniques described herein are generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband Television (HbbTV) standards, World Wide Web Consortium (W3C) standards, and Universal Plug and Play (UPnP) standard. Further, it should be noted that although techniques of this disclosure are described with respect to ITU-T H.264 and ITU-T H.265, the techniques of this disclosure are generally applicable to video coding, including omnidirectional video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265. Thus, reference to ITU-T H.264 and ITU-T H.265 is for descriptive purposes and should not be construed to limit the scope of the techniques described herein. Further, it should be noted that incorporation by reference of documents herein should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a device comprises one or more processors configured to signal a flag indicating that an immersive virtual reality space includes excluded areas and signal information specifying the excluded areas.

In one example, a non-transitory computer-readable storage medium comprises instructions stored thereon that, when executed, cause one or more processors of a device to signal a flag indicating that an immersive virtual reality space includes excluded areas and signal information specifying the excluded areas.

In one example, an apparatus comprises means for signaling a flag indicating that an immersive virtual reality space includes excluded areas and means for signaling information specifying the excluded areas.

In one example, a device comprises one or more processors configured to parse a flag indicating that an immersive virtual reality space includes excluded areas and parse information to determine the excluded areas.

In one example, a non-transitory computer-readable storage medium comprises instructions stored thereon that, when executed, cause one or more processors of a device to parse a flag indicating that an immersive virtual reality space includes excluded areas and parse information to determine the excluded areas.

In one example, an apparatus comprises means for parsing a flag indicating that an immersive virtual reality space includes excluded areas and means for parsing information to determine the excluded areas.

The details of one or more examples are set forth in the accompanying drawings and the description below. Other features, objects, and advantages will be apparent from the description and drawings, and from the claims.

Video content typically includes video sequences comprised of a series of frames. A series of frames may also be referred to as a group of pictures (GOP). Each video frame or picture may include a one or more slices, where a slice includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. As used herein, the term video block may generally refer to an area of a picture or may more specifically refer to the largest array of pixel values that may be predictively coded, sub-divisions thereof, and/or corresponding structures. Further, according to ITU-T H.265, each video frame or picture may be partitioned to include one or more tiles, where a tile is a sequence of coding tree units corresponding to a rectangular area of a picture.

In ITU-T H.265, the CTBs of a CTU may be partitioned into Coding Blocks (CB) according to a corresponding quadtree block structure. According to ITU-T H.265, one luma CB together with two corresponding chroma CBs and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level and for a CU one or more predictions corresponding to intra prediction or inter prediction may be used to generate reference samples for CBs of the CU. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples. Residual data may include respective arrays of difference values corresponding to each component of video data (e.g., luma (Y) and chroma (Cb and Cr)). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, an array of pixel difference values may be sub-divided for purposes of generating transform coefficients (e.g., four 8×8 transforms may be applied to a 16×16 array of residual values corresponding to a 16×16 luma CB), such sub-divisions may be referred to as Transform Blocks (TBs). Transform coefficients may be quantized according to a quantization parameter (QP). Quantized transform coefficients (which may be referred to as level values) may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.”

Virtual Reality (VR) applications may include video content that may be rendered with a head-mounted display, where only the area of the spherical video that corresponds to the orientation of the user's head is rendered. VR applications may be enabled by omnidirectional video, which is also referred to as 360 degree spherical video of 360 degree video. Omnidirectional video is typically captured by multiple cameras that cover up to 360 degrees of a scene. A distinct feature of omnidirectional video compared to normal video is that, typically only a subset of the entire captured video region is displayed, i.e., the area corresponding to the current user's field of view (FOV) is displayed. A FOV is sometimes also referred to as viewport. In other cases, a viewport may be described as part of the spherical video that is currently displayed and viewed by the user. It should be noted that the size of the viewport can be smaller than or equal to the field of view. Further, it should be noted that omnidirectional video may be captured using monoscopic or stereoscopic cameras. Monoscopic cameras may include cameras that capture a single view of an object. Stereoscopic cameras may include cameras that capture multiple views of the same object (e.g., views are captured using two lenses at slightly different angles). Further, it should be noted that in some cases, images for use in omnidirectional video applications may be captured using ultra wide-angle lens (i.e., so-called fisheye lens). In any case, the process for creating 360 degree spherical video may be generally described as stitching together input images and projecting the stitched together input images onto a three-dimensional structure (e.g., a sphere or cube), which may result in so-called projected frames. Further, in some cases, regions of projected frames may be transformed, resized, and relocated, which may result in a so-called packed frame.

Transmission systems may be configured to transmit omnidirectional video to one or more computing devices. Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model. The OSI model defines a 7-layer stack model, including an application layer, a presentation layer, a session layer, a transport layer, a network layer, a data link layer, and a physical layer. It should be noted that the use of the terms upper and lower with respect to describing the layers in a stack model may be based on the application layer being the uppermost layer and the physical layer being the lowermost layer. Further, in some cases, the term “Layer 1” or “L1” may be used to refer to a physical layer, the term “Layer 2” or “L2” may be used to refer to a link layer, and the term “Layer 3” or “L3” or “IP layer” may be used to refer to the network layer.

A physical layer may generally refer to a layer at which electrical signals form digital data. For example, a physical layer may refer to a layer that defines how modulated radio frequency (RF) symbols form a frame of digital data. A data link layer, which may also be referred to as a link layer, may refer to an abstraction used prior to physical layer processing at a sending side and after physical layer reception at a receiving side. As used herein, a link layer may refer to an abstraction used to transport data from a network layer to a physical layer at a sending side and used to transport data from a physical layer to a network layer at a receiving side. It should be noted that a sending side and a receiving side are logical roles and a single device may operate as both a sending side in one instance and as a receiving side in another instance. A link layer may abstract various types of data (e.g., video, audio, or application files) encapsulated in particular packet types (e.g., Motion Picture Expert Group—Transport Stream (MPEG-TS) packets, Internet Protocol Version 4 (IPv4) packets, etc.) into a single generic format for processing by a physical layer. A network layer may generally refer to a layer at which logical addressing occurs. That is, a network layer may generally provide addressing information (e.g., Internet Protocol (IP) addresses) such that data packets can be delivered to a particular node (e.g., a computing device) within a network. As used herein, the term network layer may refer to a layer above a link layer and/or a layer having data in a structure such that it may be received for link layer processing. Each of a transport layer, a session layer, a presentation layer, and an application layer may define how data is delivered for use by a user application.

ISO/IEC FDIS 23090-12:201x (E); “Information technology—Coded representation of immersive media (MPEG-I)—Part 2: Omnidirectional media format,” ISO/IEC JTC 1/SC 29/WG 11, Dec. 11, 2017, which is incorporated by reference and herein referred to as MPEG-I, defines a media application format that enables omnidirectional media applications. MPEG-I specifies a coordinate system for omnidirectional video; projection and rectangular region-wise packing methods that may be used for conversion of a spherical video sequence or image into a two-dimensional rectangular video sequence or image, respectively; storage of omnidirectional media and the associated metadata using the ISO Base Media File Format (ISOBMFF); encapsulation, signaling, and streaming of omnidirectional media in a media streaming system; and media profiles and presentation profiles. It should be noted that for the sake of brevity, a complete description of MPEG-I is not provided herein. However, reference is made to relevant sections of MPEG-I.

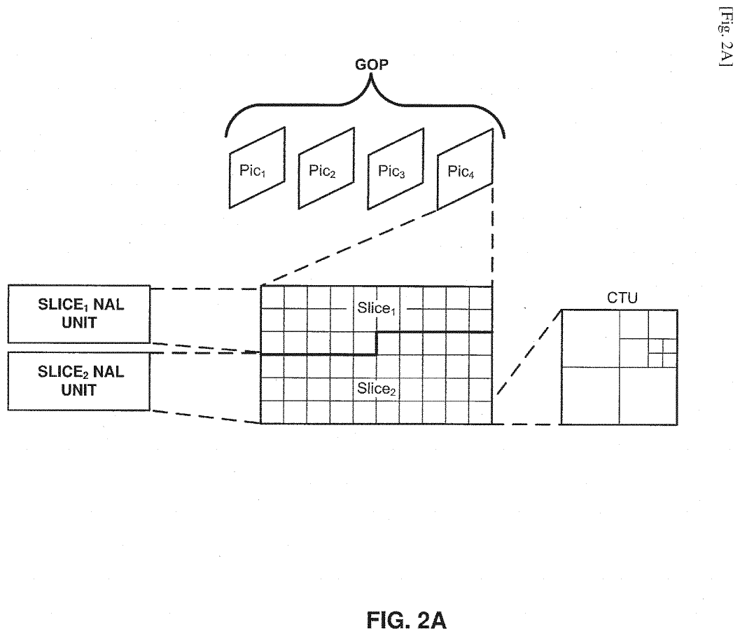

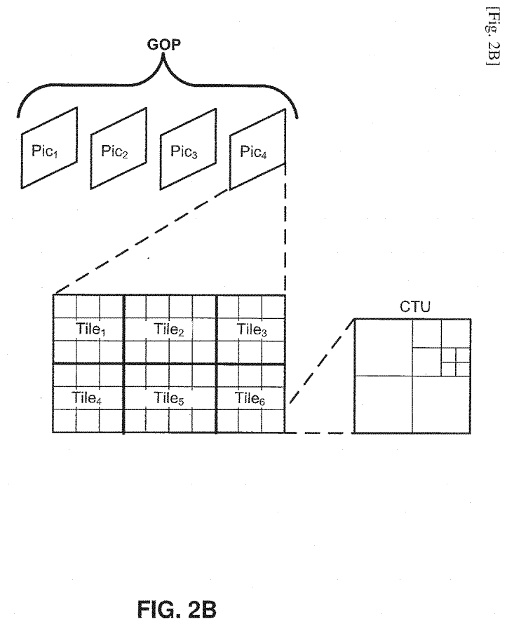

MPEG-I provides media profiles where video is coded according to ITU-T H.265. ITU-T H.265 is described in High Efficiency Video Coding (HEVC), Rec. ITU-T H.265 December 2016, which is incorporated by reference, and referred to herein as ITU-T H.265. As described above, according to ITU-T H.265, each video frame or picture may be partitioned to include one or more slices and further partitioned to include one or more tiles. FIGS. 2A-2B are conceptual diagrams illustrating an example of a group of pictures including slices and further partitioning pictures into tiles. In the example illustrated in FIG. 2A, Pic4 is illustrated as including two slices (i.e., Slice1 and Slice2) where each slice includes a sequence of CTUs (e.g., in raster scan order). In the example illustrated in FIG. 2B, Pic4 is illustrated as including six tiles (i.e., Tile1 to Tile6), where each tile is rectangular and includes a sequence of CTUs. It should be noted that in ITU-T H.265, a tile may consist of coding tree units contained in more than one slice and a slice may consist of coding tree units contained in more than one tile. However, ITU-T H.265 provides that one or both of the following conditions shall be fulfilled: (1) All coding tree units in a slice belong to the same tile; and (2) All coding tree units in a tile belong to the same slice.

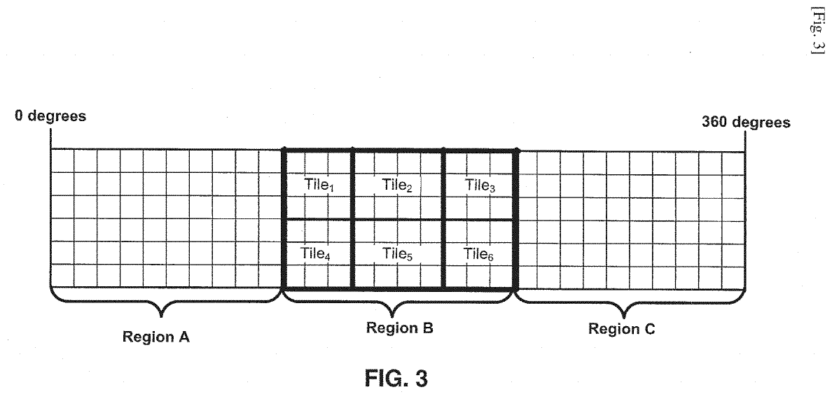

360 degree spherical video may include regions. Referring to the example illustrated in FIG. 3, the 360 degree spherical video includes Regions A, B, and C and as illustrated in FIG. 3, tiles (i.e., Tile1 to Tile6) may form a region of an omnidirectional video. In the example illustrated in FIG. 3, each of the regions are illustrated as including CTUs. As described above, CTUs may form slices of coded video data and/or tiles of video data. Further, as described above, video coding techniques may code areas of a picture according to video blocks, sub-divisions thereof, and/or corresponding structures and it should be noted that video coding techniques enable video coding parameters to be adjusted at various levels of a video coding structure, e.g., adjusted for slices, tiles, video blocks, and/or at sub-divisions. In one example, the 360 degree video illustrated in FIG. 3 may represent a sporting event where Region A and Region C include views of the stands of a stadium and Regions B includes a view of the playing field (e.g., the video is captured by a 360 degree camera placed at the 50-yard line).

As described above, a viewport may be part of the spherical video that is currently displayed and viewed by the user. As such, regions of omnidirectional video may be selectively delivered depending on the user's viewport, i.e., viewport-dependent delivery may be enabled in omnidirectional video streaming. Typically, to enable viewport-dependent delivery, source content is split into sub-picture sequences before encoding, where each sub-picture sequence covers a subset of the spatial area of the omnidirectional video content, and sub-picture sequences are then encoded independently from each other as a single-layer bitstream. For example, referring to FIG. 3, each of Region A, Region B, and Region C, or portions thereof, may correspond to independently coded sub-picture bitstreams. Each sub-picture bitstream may be encapsulated in a file as its own track and tracks may be selectively delivered to a receiver device based on viewport information. It should be noted that in some cases, it is possible that sub-pictures overlap. For example, referring to FIG. 3, Tile1, Tile2, Tile4, and Tile5 may form a sub-picture and Tile2, Tile3, Tile5, and Tile6 may form a sub-picture. Thus, a particular sample may be included in multiple sub-pictures. MPEG-I provides where a composition-aligned sample includes one of a sample in a track that is associated with another track, the sample has the same composition time as a particular sample in the another track, or, when a sample with the same composition time is not available in the another track, the closest preceding composition time relative to that of a particular sample in the another track. Further, MPEG-I provides where a constituent picture includes part of a spatially frame-packed stereoscopic picture that corresponds to one view, or a picture itself when frame packing is not in use or the temporal interleaving frame packing arrangement is in use.

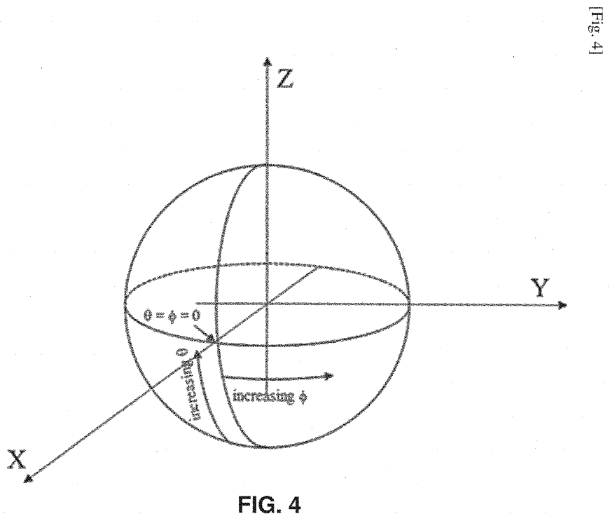

As described above, MPEG-I specifies a coordinate system for omnidirectional video. In MPEG-I, the coordinate system consists of a unit sphere and three coordinate axes, namely the X (back-to-front) axis, the Y (lateral, side-to-side) axis, and the Z (vertical, up) axis, where the three axes cross at the center of the sphere. The location of a point on the sphere is identified by a pair of sphere coordinates azimuth (φ) and elevation (θ). FIG. 4 illustrates the relation of the sphere coordinates azimuth (φ) and elevation (θ) to the X, Y, and Z coordinate axes as specified in MPEG-I. It should be noted that in MPEG-I the value ranges of azimuth is −180.0, inclusive, to 180.0, exclusive, degrees and the value range of elevation is −90.0 to 90.0, inclusive, degrees. MPEG-I specifies where a region on a sphere may be specified by four great circles, where a great circle (also referred to as a Riemannian circle) is an intersection of the sphere and a plane that passes through the center point of the sphere, where the center of the sphere and the center of a great circle are co-located. MPEG-I further describes where a region on a sphere may be specified by two azimuth circles and two elevation circles, where a azimuth circle is a circle on the sphere connecting all points with the same azimuth value, and an elevation circle is a circle on the sphere connecting all points with the same elevation value. The sphere region structure in MPEG-I forms the basis for signaling various types of metadata.

It should be noted that with respect to the equations used herein, the following arithmetic operators may be used:
+ Addition
− Subtraction (as a two-argument operator) or negation (as a unary prefix operator)
Multiplication, including matrix multiplication
x^{y} Exponentiation. Specifies x to the power of y. In other contexts, such notation is used for superscripting not intended for interpretation as exponentiation.
/Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.
x % y Modulus. Remainder of x divided by y, defined only for integers x and y with x>=0 and y>0.

It should be noted that with respect to the equations used herein, the following logical operators may be used:

x && y Boolean logical “and” of x and y
x | | y Boolean logical “or” of x and y
! Boolean logical “not”
x ? y : z If x is TRUE or not equal to 0,
evaluates to the value of y; otherwise,
evaluates to the value of z.

It should be noted that with respect to the equations used herein, the following relational operators may be used:

| | |
|---|---|
| > | Greater than |
| >= | Greater than or equal to |
| < | Less than |
| <= | Less than or equal to |
| == | Equal to |
| != | Not equal to |

It should be noted in the syntax used herein, unsigned int(n) refers to an unsigned integer having n-bits. Further, bit(n) refers to a bit value having n-bits.

As described above, MPEG-I specifies how to store omnidirectional media and the associated metadata using the International Organization for Standardization (ISO) base media file format (ISOBMFF). MPEG-I specifies where a file format that supports metadata specifying the area of the spherical surface covered by the projected frame. In particular, MPEG-I includes a sphere region structure specifying a sphere region having the following definition, syntax and semantic:

### Definition

The sphere region structure (SphereRegionStruct) specifies a sphere region.

When centre_tilt is equal to 0, the sphere region specified by this structure is derived as follows:
If both azimuth_range and elevation_range are equal to 0, the sphere region specified by this structure is a point on a spherical surface.
Otherwise, the sphere region is defined using variables centreAzimuth, centreElevation, cAzimuth1, cAzimuth, cElevation1, and cElevation2 derived as follows:

centreAzimuth=centre_azimuth÷65536

centreElevation=centre_elevation÷65536

cAzimuth1=(centre_azimuth−azimuth_range÷2)÷65536

cAzimuth2=(centre_azimuth+azimuth_range÷2)÷65536

cElevation1=(centre_elevation−elevation_range÷2)÷65536

cElevation2=(centre_elevation+elevation_range÷2)÷65536

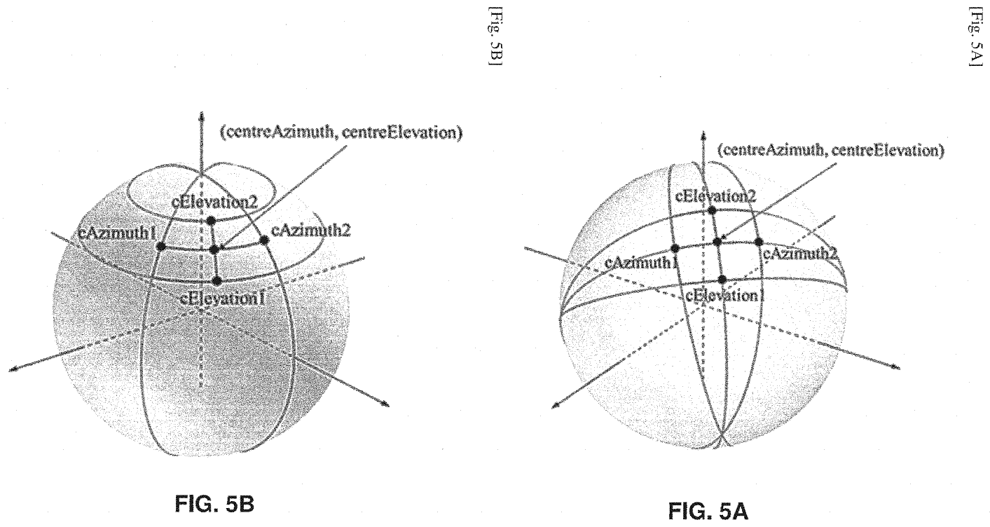

The sphere region is defined as follows with reference to the shape type value specified in the semantics of the structure containing this instance of SphereRegionStruct:
When the shape type value is equal to 0, the sphere region is specified by four great circles defined by four points cAzimuth1, cAzimuth2, cElevation1, cElevation2 and the centre point defined by centreAzimuth and centreElevation and as shown in FIG. 5A.
When the shape type value is equal to 1, the sphere region is specified by two azimuth circles and two elevation circles defined by four points cAzimuth1, cAzimuth2, cElevation1, cElevation2 and the centre point defined by centreAzimuth and centreElevation and as shown in FIG. 5B.

When centre_tilt is not equal to 0, the sphere region is firstly derived as above and then a tilt rotation is applied along the axis originating from the sphere origin passing through the centre point of the sphere region, where the angle value increases clockwise when looking from the origin towards the positive end of the axis. The final sphere region is the one after applying the tilt rotation.

Shape type value equal to 0 specifies that the sphere region is specified by four great circles as illustrated in FIG. 5A.

Shape type value equal to 1 specifies that the sphere region is specified by two azimuth circles and two elevation circles as illustrated in 5B.

Shape type values greater than 1 are reserved.

Syntax

aligned(8) SphereRegionStruct(range_included_flag) {

signed int(32) centre_azimuth;
signed int(32) centre_elevation;
singed int(32) centre_tilt;
if (range_included_flag) {

unsigned int(32) azimuth_range;
unsigned int(32) elevation_range;

}
unsigned int(1) interpolate;
bit(7) reserved = 0;

}

### Semantics

centre_azimuth and centre_elevation specify the centre of the sphere region. centre_azimuth shall be in the range of −180*2¹⁶ to 180*2¹⁶−1, inclusive. centre_elevation shall be in the range of −90*2¹⁶ to 90*2¹⁶, inclusive.
centre_tilt specifies the tilt angle of the sphere region. centre_tilt shall be in the range of −180*2¹⁶ to 180*2¹⁶−1, inclusive.
azimuth_range and elevation_range, when present, specify the azimuth and elevation ranges, respectively, of the sphere region specified by this structure in units of 2⁻¹⁶ degrees. azimuth_range and elevation_range specify the range through the centre point of the sphere region, as illustrated by FIG. 5A or FIG. 5B. When azimuth_range and elevation_range are not present in this instance of SphereRegionStruct, they are inferred as specified in the semantics of the structure containing this instance of SphereRegionStruct. azimuth_range shall be in the range of 0 to 360*2¹⁶, inclusive. elevation_range shall be in the range of 0 to 180*2¹⁶, inclusive.
The semantics of interpolate are specified by the semantics of the structure containing this instance of SphereRegionStruct.

As described above, the sphere region structure in MPEG-I forms the basis for signaling various types of metadata. With respect to specifying a generic timed metadata track syntax for sphere regions, MPEG-I specifies a sample entry and a sample format. The sample entry structure is specified as having the following definition, syntax and semantics:

### Definition

Exactly one SphereRegionConfigBox shall be present in the sample entry. SphereRegionConfigBox specifies the shape of the sphere region specified by the samples. When the azimuth and elevation ranges of the sphere region in the samples do not change, they may be indicated in the sample entry.

Syntax

class SphereRegionSampleEntry(type) extends
MetaDataSampleEntry(type) {

SphereRegionConfigBox( ); // mandatory
Box[ ] other_boxes; // optional

}
class SphereRegionConfigBox extends FullBox(‘rosc’, 0, 0) {

unsigned int(8) shape_type;
bit(7) reserved = 0;
unsigned int(1) dynamic_range_flag;
if (dynamic_range_flag == 0) {

unsigned int(32) static_azimuth_range;
unsigned int(32) static_elevation_range;

}
unsigned int(8) num_regions;

}

### Semantics

shape_type equal to 0 specifies that the sphere region is specified by four great circles. shape_type equal to 1 specifies that the sphere region is specified by two azimuth circles and two elevation circles. shape_type values greater than 1 are reserved. The value of shape_type is used as the shape type value when applying the clause describing the Sphere region (provided above) to the semantics of the samples of the sphere region metadata track.
dynamic_range_flag equal to 0 specifies that the azimuth and elevation ranges of the sphere region remain unchanged in all samples referring to this sample entry. dynamic_range_flag equal to 1 specifies that the azimuth and elevation ranges of the sphere region are indicated in the sample format.
static_azimuth_range and static_elevation_range specify the azimuth and elevation ranges, respectively, of the sphere region for each sample referring to this sample entry in units of 2⁻¹⁶ degrees. static_azimuth_range and static_elevation_range specify the ranges through the centre point of the sphere region, as illustrated by FIG. 5A or FIG. 5B. static_azimuth_range shall be in the range of 0 to 360*2¹⁶, inclusive. static_elevation_range shall be in the range of 0 to 180*2¹⁶, inclusive. When static_azimuth_range and static_elevation_range are present and are both equal to 0, the sphere region for each sample referring to this sample entry is a point on a spherical surface. When static_azimuth_range and static_elevation_range are present, the values of azimuth_range and elevation_range are inferred to be equal to static_azimuth_range and static_elevation_range, respectively, when applying the clause describing the Sphere region (provided above) to the semantics of the samples of the sphere region metadata track.
num_regions specifies the number of sphere regions in the samples referring to this sample entry. num_regions shall be equal to 1. Other values of num_regions are reserved.

The sample format structure is specified as having the following definition, syntax and semantics:

### Definition

Each sample specifies a sphere region. The SphereRegionSample structure may be extended in derived track formats.

Syntax

aligned(8) SphereRegionSample( ) {
for (i = 0; i < num_regions; i++)

SphereRegionStruct(dynamic_range_flag)

}

Semantics

The sphere region structure clause, provided above, applies to the sample that contains the SphereRegionStruct structure.

Let the target media samples be the media samples in the referenced media tracks with composition times greater than or equal to the composition time of this sample and less than the composition time of the next sample.

interpolate equal to 0 specifies that the values of centre_azimuth, centre_elevation, centre_tilt. azimuth_range (if present), and elevation_range (if present) in this sample apply to the target media samples. interpolate equal to 1 specifies that the values of centre_azimuth, centre_elevation, centre_tilt, azimuth_range (if present), and elevation_range (if present) that apply to the target media samples are linearly interpolated from the values of the corresponding fields in this sample and the previous sample.

The value of interpolate for a sync sample, the first sample of the track, and the first sample of a track fragment shall be equal to 0.

In MPEG-I timed metadata may be signaled based on a sample entry and a sample format. For example, MPEG-I includes an initial viewing orientation metadata having the following definition, syntax and semantics:

### Definition

This metadata indicates initial viewing orientations that should be used when playing the associated media tracks or a single omnidirectional image stored as an image item. In the absence of this type of metadata centre_azimuth, centre_elevation, and centre_tilt should all be inferred to be equal to 0.

An OMAF (omnidirectional media format) player should use the indicated or inferred centre_azimuth, centre_elevation, and centre_tilt values as follows:
If the orientation/viewport metadata of the OMAF player is obtained on the basis of an orientation sensor included in or attached to a viewing device, the OMAF player should
obey only the centre_azimuth value, and
ignore the values of centre_elevation and centre_tilt and use the respective values from the orientation sensor instead.
Otherwise, the OMAF player should obey all three of centre_azimuth, centre_elevation, and centre_tilt.

The track sample entry type ‘initial view orientation timed metadata’ shall be used. shape_type shall be equal to 0, dynamic_range_flag shall be equal to 0, static_azimuth_range shall be equal to 0, and static_elevation_range shall be equal to 0 in the SphereRegionConfigBox of the sample entry.
NOTE: This metadata applies to any viewport regardless of which azimuth and elevation ranges are covered by the viewport. Thus, dynamic_range_flag, static_azimuth_range, and static_elevation_range do not affect the dimensions of the viewport that this metadata concerns and are hence required to be equal to 0. When the OMAF player obeys the centre_tilt value as concluded above, the value of centre_tilt could be interpreted by setting the azimuth and elevation ranges for the sphere region of the viewport equal to those that are actually used in displaying the viewport.

Syntax

class InitialViewingOrientationSample( ) extends
SphereRegionSample( ) {

unsigned int(1) refresh_flag;
bit(7) reserved = 0;

}

Semantics
NOTE 1: As the sample structure extends from SphereRegionSample, the syntax elements of SphereRegionSample are included in the sample.
   centre_azimuth, centre_elevation, and centre_tilt specify the viewing orientation in units of 2⁻¹⁶ degrees relative to the global coordinate axes. centre_azimuth and centre_elevation indicate the centre of the viewport, and centre_tilt indicates the tilt angle of the viewport.
   interpolate shall be equal to 0.
   refresh_flag equal to 0 specifies that the indicated viewing orientation should be used when starting the playback from a time-parallel sample in an associated media track. refresh_flag equal to 1 specifies that the indicated viewing orientation should always be used when rendering the time-parallel sample of each associated media track, i.e., both in continuous playback and when starting the playback from the time-parallel sample.
NOTE 2: refresh_flag equal to 1 enables the content author to indicate that a particular viewing orientation is recommended even when playing the video continuously. For example, refresh_flag equal to 1 could be indicated for a scene cut position.

As described above, MPEG-I specifies projection and rectangular region-wise packing methods that may be used for conversion of a spherical video sequence into a two-dimensional rectangular video sequence. In this manner, MPEG-I specifies a region-wise packing structure having the following definition, syntax, and semantics:

### Definition

RegionWisePackingStruct specifies the mapping between packed regions and the respective projected regions and specifies the location and size of the guard bands, if any.
NOTE: Among other information the RegionWisePackingStruct also provides the content coverage information in the 2D Cartesian picture domain.
   A decoded picture in the semantics of this clause is either one of the following depending on the container for this syntax structure:
For video, the decoded picture is the decoding output resulting from a sample of the video track.
For an image item, the decoded picture is a reconstructed image of the image item.

The content of RegionWisePackingStruct is informatively summarized below, while the normative semantics follow subsequently in this clause:
The width and height of the projected picture are explicitly signalled with proj_picture_width and proj_picture_height, respectively.
The width and height of the packed picture are explicitly signalled with packed_picture_width and packed_picture_height, respectively.
When the projected picture is stereoscopic and has the top-bottom or side-by-side frame packing arrangement, constituent_picture_matching_flag equal to 1 specifies that
   the projected region information, packed region information, and guard band region information in this syntax structure apply individually to each constituent picture,
   the packed picture and the projected picture have the same stereoscopic frame packing format, and
   the number of projected regions and packed regions is double of that indicated by the value of num_regions in the syntax structure.
RegionWisePackingStruct contains a loop, in which a loop entry corresponds to the respective projected regions and packed regions in both constituent pictures (when constituent_picture_matching_flag equal to 1) or to a projected region and the respective packed region (when constituent_picture_matching_flag equal to 0), and the loop entry the contains the following:
   a flag indicating the presence of guard bands for the packed region,
   the packing type (however, only rectangular region-wise packing is specified in MPEG-I),
   the mapping between a projected region and the respective packed region in the rectangular region packing structure RectRegionPacking(i),
   when guard bands are present, the guard band structure for the packed region GuardBand(i).

The content of the rectangular region packing structure RectRegionPacking(i) is informatively summarized below, while the normative semantics follow subsequently in this clause:
proj_reg_width[i], proj_reg_height[i], proj_reg_top[i], and proj_reg_left[i] specify the width, height, top offset, and left offset, respectively, of the i-th projected region.
transform_type[i] specifies the rotation and mirroring, if any, that are applied to the i-th packed region to remap it to the i-th projected region.
packed_reg_width[i], packed_reg_height[i], packed_reg_top[i], and packed_reg_left[i] specify the width, height, the top offset, and the left offset, respectively, of the i-th packed region.

The content of the guard band structure GuardBand(i) is informatively summarized below, while the normative semantics follow subsequently in this clause:
left gb_width[i], right_gb_width[i], top_gb_height[i], or bottom_gb_height[i] specify the guard band size on the left side of, the right side of, above, or below, respectively, the i-th packed region.
gb_not_used_for_pred_flag[i] indicates if the encoding was constrained in a manner that guards bands are not used as a reference in the inter prediction process.
gb_type[i][j] specifies the type of the guard bands for the i-th packed region.

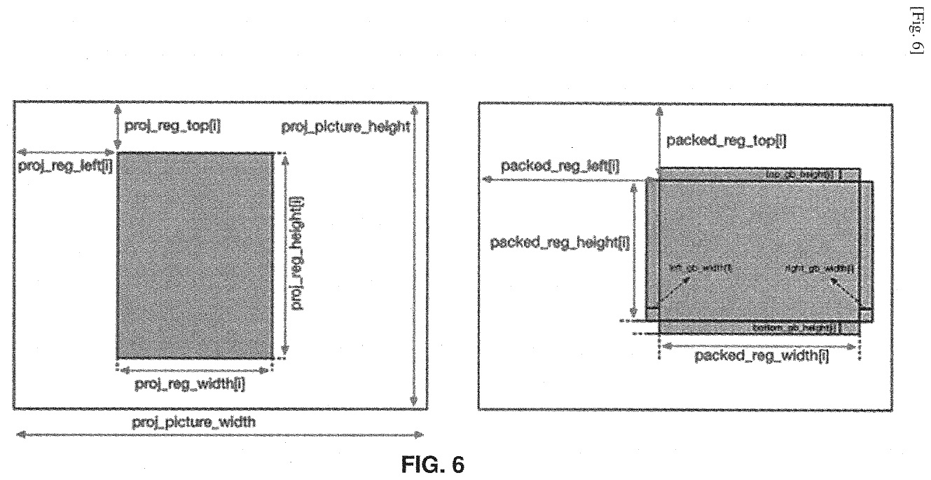

FIG. 6 illustrates an example of the position and size of a projected region within a projected picture (on the left side) as well as that of a packed region within a packed picture with guard bands (on the right side). This example applies when the value of constituent_picture_matching_flag is equal to 0.

Syntax

aligned(8) class RectRegionPacking(i) {

unsigned int(32) proj_reg_width[i];
unsigned int(32) proj_reg_height[i];
unsigned int(32) proj_reg_top[i];
unsigned int(32) proj_reg_left[i];
unsigned int(3) transform_type[i];
bit(5) reserved = 0;
unsigned int(16) packed_reg_width[i];
unsigned int(16) packed_reg_height[i];
unsigned int(16) packed_reg_top[i];
unsigned int(16) packed_reg_left[i];

}

Semantics

proj_reg_width[i], proj_reg_height[i], proj_reg_top[i], and proj_reg_left[i] specify the width, height, top offset, and left offset, respectively, of the i-th projected region, either within the projected picture (when constituent_picture_matching_flag is equal to 0) or within the constituent picture of the projected picture (when constituent_picture_matching_flag is equal to 1). proj_reg_width[i], proj_reg_height[i], proj_reg_top[i] and proj_reg_left[i] are indicated in relative projected picture sample units.
NOTE 1: Two projected regions may partially or entirely overlap with each other. When there is an indication of quality difference, e.g., by a region-wise quality ranking indication, then for the overlapping area of any two overlapping projected regions, the packed region corresponding to the projected region that is indicated to have higher quality should be used for rendering.

transform_type[i] specifies the rotation and mirroring that is applied to the i-th packed region to remap it to the i-th projected region. When transform_type[i] specifies both rotation and mirroring, rotation is applied before mirroring for converting sample locations of a packed region to sample locations of a projected region. The following values are specified:
0: no transform
1: mirroring horizontally
2: rotation by 180 degrees (counter-clockwise)
3: rotation by 180 degrees (counter-clockwise) before mirroring horizontally
4: rotation by 90 degrees (counter-clockwise) before mirroring horizontally
5: rotation by 90 degrees (counter-clockwise)
6: rotation by 270 degrees (counter-clockwise) before mirroring horizontally
7: rotation by 270 degrees (counter-clockwise)
   NOTE 2: MPEG-I specifies the semantics of transform_type[i] for converting a sample location of a packed region in a packed picture to a sample location of a projected region in a projected picture.

packed_reg_width[i], packed_reg_height[i], packed_reg_top[i], and packed_reg_left[i] specify the width, height, the offset, and the left offset, respectively, of the i-th packed region, either within the packed picture (when constituent_picture_matching_flag is equal to 0) or within each constituent picture of the packed picture (when constituent_picture_matching_flag is equal to 1). packed_reg_width[i], packed_reg_height[i], packed_reg_top[i], and packed_reg_left[i] are indicated in relative packed picture sample units. packed_reg_width[i], packed_reg_height[i], packed_reg_top[i], and packed_reg_left[i] shall represent integer horizontal and vertical coordinates of luma sample units within the decoded pictures.
NOTE: Two packed regions may partially or entirely overlap with each other.

MPEG-I further specifies the inverse of the rectangular region-wise packing process for remapping of a luma sample location in a packed region onto a luma sample location of the corresponding projected region:

Inputs to this process are:
sample location (x, y) within the packed region, where x and y are in relative packed picture sample units, while the sample location is at an integer sample location within the packed picture,
the width and the height (projRegWidth, projRegHeight) of the projected region, in relative projected picture sample units,
the width and the height (packedRegWidth, packedRegHeight) of the packed region, in relative packed picture sample units,
transform type (transformType), and
offset values for the sampling position (offsetX, offsetY) in the range of 0, inclusive, to 1, exclusive, in horizontal and vertical relative packed picture sample units, respectively.
NOTE: offsetX and offsetY both equal to 0.5 indicate a sampling position that is in the centre point of a sample in packed picture sample units.
   Outputs of this process are:
the centre point of the sample location (hPos, vPos) within the projected region, where hPos and vPos are in relative projected picture sample units and may have non-integer real values.
   The outputs are derived as follows:

if( transformType = = 0 | | transformType = = 1 | |
transformType = = 2 | | transformType = = 3 ) {

horRatio = projRegWidth ÷ packedRegWidth
verRatio = projRegHeight ÷ packedRegHeight

} else if ( transformType = = 4 | | transformType = = 5 | |
transformType = = 6 | |

transformType = = 7 ) {
horRatio = projRegWidth ÷ packedRegHeight
verRatio = projRegHeight ÷ packedRegWidth

}
if( transformType = = 0 ) {

hPos = horRatio * ( x + offsetX )
vPos = verRatio * ( y + offsetY )

} else if ( transformType = = 1 ) {

hPos = horRatio * ( packedRegWidth − x − offsetX ) (5 4)
vPos = verRatio * ( y + offsetY )

} else if ( transformType = = 2 ) {

hPos = horRatio * ( packedRegWidth − x − offsetX )
vPos = verRatio * ( packedRegHeight − y − offsetY )

} else if ( transformType = = 3 ) {

hPos = horRatio * ( x + offsetX )
vPos = verRatio * ( packedRegHeight − y − offsetY )

} else if ( transformType = = 4 ) {

hPos = horRatio * ( y + offsetY )
vPos = verRatio * ( x + offsetX )

} else if ( transformType = = 5 ) {

hPos = horRatio * ( y + offsetY )
vPos = verRatio * ( packedRegWidth − x − offsetX )

} else if ( transformType = = 6 ) {

hPos = horRatio * ( packedRegHeight − y − offsetY )
vPos = verRatio * ( packedRegWidth − x − offsetX )

} else if ( transformType = = 7 ) {

hPos = horRatio * ( packedRegHeight − y − offsetY )
vPos = verRatio * ( x+ offsetX )

}

It should be noted that for the sake for brevity the complete syntax and semantics of the rectangular region packing structure, the guard band structure, and the region-wise packing structure are not provide herein. Further, the complete derivation of region-wise packing variables and constraints for the syntax elements of the region-wise packing structure are not provide herein. However, reference is made to the relevant section of MPEG-I.

As described above, MPEG-I specifies encapsulation, signaling, and streaming of omnidirectional media in a media streaming system. In particular, MPEG-I specifies how to encapsulate, signal, and stream omnidirectional media using dynamic adaptive streaming over Hypertext Transfer Protocol (HTTP) (DASH). DASH is described in ISO/IEC: ISO/IEC 23009-1:2014, “Information technology—Dynamic adaptive streaming over HTTP (DASH)—Part 1: Media presentation description and segment formats,” International Organization for Standardization, 2nd Edition, May 15, 2014 (hereinafter, “ISO/IEC 23009-1:2014”), which is incorporated by reference herein. A DASH media presentation may include data segments, video segments, and audio segments. In some examples, a DASH Media Presentation may correspond to a linear service or part of a linear service of a given duration defined by a service provider (e.g., a single TV program, or the set of contiguous linear TV programs over a period of time). According to DASH, a Media Presentation Description (MPD) is a document that includes metadata required by a DASH Client to construct appropriate HTTP-URLs to access segments and to provide the streaming service to the user. A MPD document fragment may include a set of eXtensible Markup Language (XML)-encoded metadata fragments. The contents of the MPD provide the resource identifiers for segments and the context for the identified resources within the Media Presentation. The data structure and semantics of the MPD fragment are described with respect to ISO/IEC 23009-1:2014. Further, it should be noted that draft editions of ISO/IEC 23009-1 are currently being proposed. Thus, as used herein, a MPD may include a MPD as described in ISO/IEC 23009-1:2014, currently proposed MPDs, and/or combinations thereof. In ISO/IEC 23009-1:2014, a media presentation as described in a MPD may include a sequence of one or more Periods, where each Period may include one or more Adaptation Sets. It should be noted that in the case where an Adaptation Set includes multiple media content components, then each media content component may be described individually. Each Adaptation Set may include one or more Representations. In ISO/IEC 23009-1:2014 each Representation is provided: (1) as a single Segment, where Subsegments are aligned across Representations with an Adaptation Set; and (2) as a sequence of Segments where each Segment is addressable by a template-generated Universal Resource Locator (URL). The properties of each media content component may be described by an AdaptationSet element and/or elements within an Adaption Set, including for example, a ContentComponent element. It should be noted that the sphere region structure forms the basis of DASH descriptor signaling for various descriptors.

According to the coordinate system described above, in MPEG-I in an OMAF player the user's viewing perspective is from the center of the sphere looking outward towards the inside surface of the sphere and only three degrees of freedom (3DOF) are supported. Thus, MPEG-I may be less than ideal in that applications including additional degrees of freedom, e.g., six degrees of freedom (6DOF) or so-called 3DOF+applications, or so-called system which has video with parallax where a user's viewing perspective may move from the center of the sphere are not supported. In another example parallax may be called head-motion parallax and may be defined as displacement or difference in the apparent position of an object viewed from different viewing positions or viewing orientations. As described in further detail below, the techniques described herein, may be used to signal a user's (or object's or region's) position information and additionally, signal the limits of allowed user position movement beyond which a VR system does not allow immersive experience and/or may lose viewer tracking capability. Further, a generic position information structure is described which may be used for signaling various types metadata. In one example, according to the techniques described herein, various pieces of metadata signaled in MPEG-I which use the sphere region structure can be augmented by additionally signaling position information structure, as described herein. In another example the user's viewing perspective may be called viewing position or set of viewing positions. In yet another example the user's viewing perspective may be called a viewpoint or set of viewpoints.

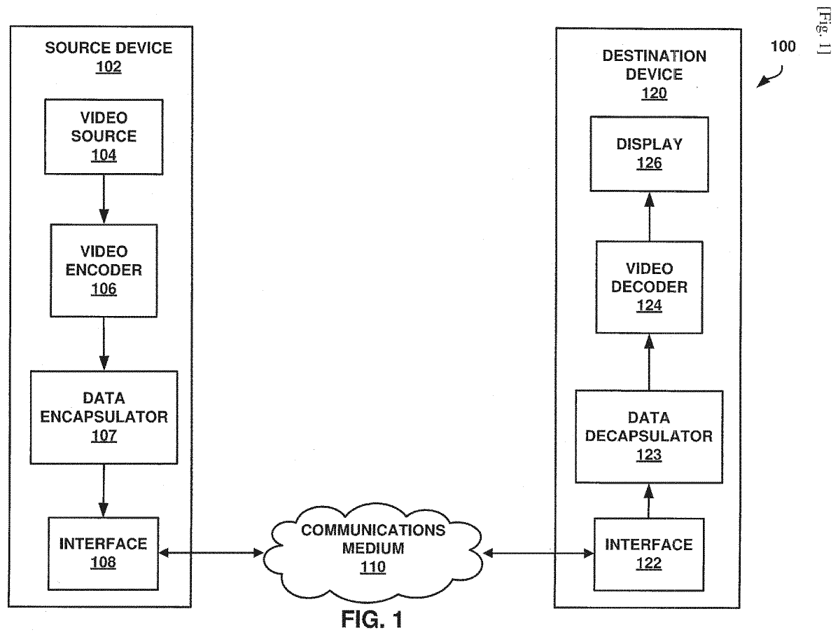

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers, gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

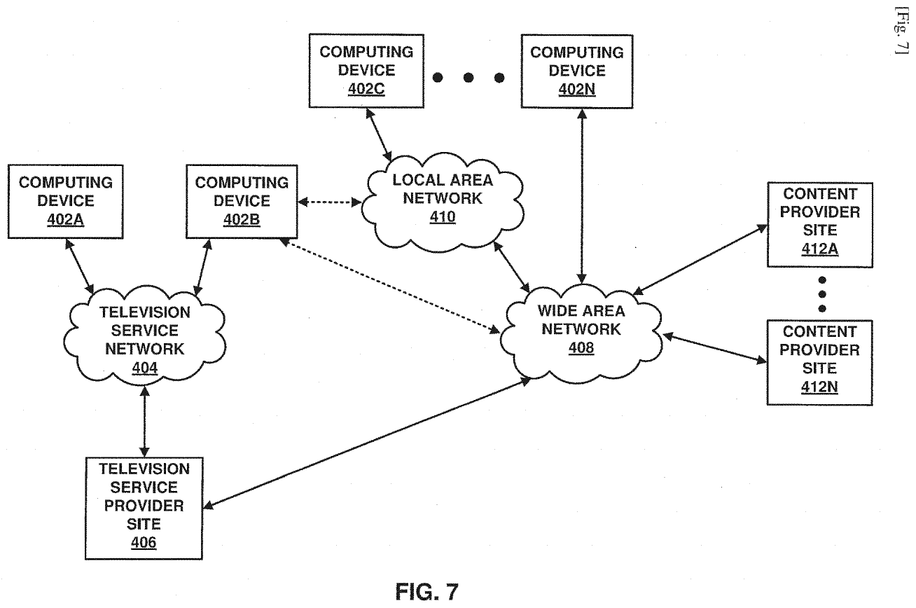

FIG. 7 is a conceptual drawing illustrating an example of components that may be included in an implementation of system 100. In the example implementation illustrated in FIG. 7, system 100 includes one or more computing devices 402A-402N, television service network 404, television service provider site 406, wide area network 408, local area network 410, and one or more content provider sites 412A-412N. The implementation illustrated in FIG. 7 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 7, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephones, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 7, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink. Further, as illustrated in FIG. 7, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 480 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 7, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats.

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible to a viewer) or lossless.

Referring again to FIG. 1, data encapsulator 107 may receive encoded video data and generate a compliant bitstream, e.g., a sequence of NAL units according to a defined data structure. A device receiving a compliant bitstream can reproduce video data therefrom. It should be noted that the term conforming bitstream may be used in place of the term compliant bitstream. It should be noted that data encapsulator 107 need not necessary be located in the same physical device as video encoder 106. For example, functions described as being performed by video encoder 106 and data encapsulator 107 may be distributed among devices illustrated in FIG. 7.

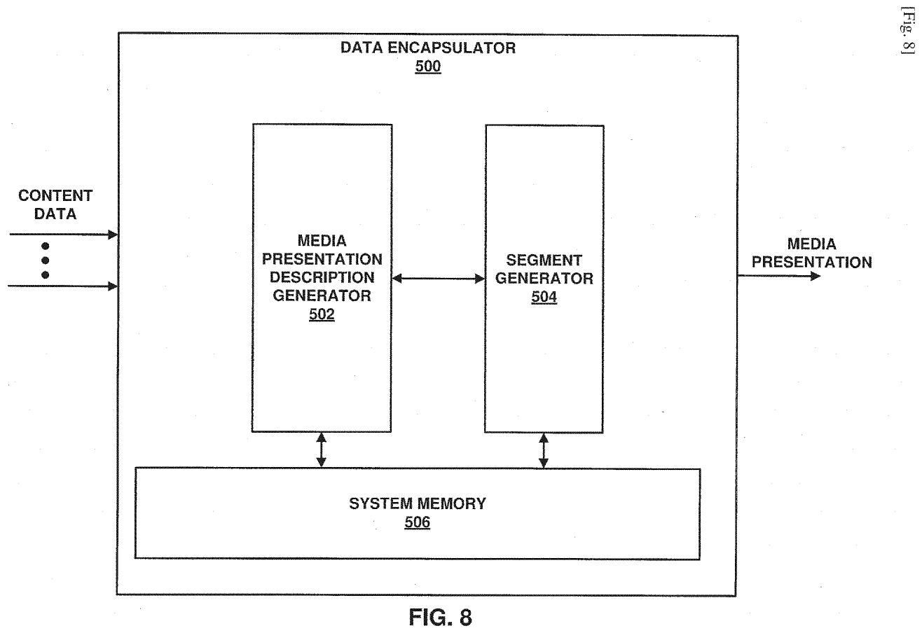

In one example, data encapsulator 107 may include a data encapsulator configured to receive one or more media components and generate media presentation based on DASH. FIG. 8 is a block diagram illustrating an example of a data encapsulator that may implement one or more techniques of this disclosure. Data encapsulator 500 may be configured to generate a media presentation according to the techniques described herein. In the example illustrated in FIG. 8, functional blocks of component encapsulator 500 correspond to functional blocks for generating a media presentation (e.g., a DASH media presentation). As illustrated in FIG. 8, component encapsulator 500 includes media presentation description generator 502, segment generator 504, and system memory 506. Each of media presentation description generator 502, segment generator 504, and system memory 506 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although data encapsulator 500 is illustrated as having distinct functional blocks, such an illustration is for descriptive purposes and does not limit data encapsulator 500 to a particular hardware architecture. Functions of data encapsulator 500 may be realized using any combination of hardware, firmware and/or software implementations.

Media presentation description generator 502 may be configured to generate media presentation description fragments. Segment generator 504 may be configured to receive media components and generate one or more segments for inclusion in a media presentation. System memory 506 may be described as a non-transitory or tangible computer-readable storage medium. In some examples, system memory 506 may provide temporary and/or long-term storage. In some examples, system memory 506 or portions thereof may be described as non-volatile memory and in other examples portions of system memory 506 may be described as volatile memory. System memory 506 may be configured to store information that may be used by data encapsulator during operation.

As described above, MPEG-I does not support applications where a user's viewing perspective may move from the center of the sphere. In one example, according to the techniques described herein, data encapsulator 107 may be configured to signal position information based on the following example definition, syntax, and semantics:

### Definition

The position structure (PositionStruct) specifies a position information and position limits information.
If xMin, xMax, yMin, yMax, zMin, zMax are all equal to 0, the structure specifies a point in 3D space.
Otherwise, the structure specifies a region in 3D space with an anchor position in that 3D region.

Syntax

aligned(8) PositionStruct(limits_flag) {

float xPosition;
float yPosition;
float zPosition;
if (limits_flag) {

float xMin;
float xMax;
float yMin;
float yMax;
float zMin;
float zMax;

}

}

Semantics

xPosition, yPosition and zPosition specify the position in 3D space in suitable units with (0,0,0) as the center of the global coordinate system.

xPosition shall be in the range of xMin and xMax, inclusive.
yPosition shall be in the range of yMin and yMax, inclusive.
zPosition shall be in the range of zMin and zMax, inclusive.
xMin, yMin and zMin specify the minimum value of X, Y, Z coordinates in suitable units in the global coordinate system respectively corresponding to 3D region specified by this structure.
xMax, yMax and zMax specify the maximum value of X, Y, Z coordinates in suitable units in the global coordinate system respectively corresponding to 3D region specified by this structure.

If limits_flag is equal to 0 the values of xMin, yMin, zMin, are each inferred to be equal to 0 and xMax, yMax and zMax are each inferred to be equal to 1.

It should be noted that with respect to the semantics described herein, suitable units may include one of: meters, centimeters, or millimeters and the semantics may correspond to a local coordinate system instead of a global coordinate system. Further, fixed point values and/or signed 32-bit integer values may be used instead of floating point values for the syntax elements. Example syntax and semantics for these may be as shown below.

```
aligned(8) PositionStruct(limits_flag) {
  unsigned int(32) xPosition;
  unsigned int(32) yPosition;
  unsigned int(32) zPosition;
  if (limits_flag) {
```

VRBB( )
}

}
aligned(8) class VRBB( ) {

signed int(32) xMin;
signed int(32) xMax;
signed int(32) yMin;
signed int(32) yMax;
signed int(32) zMin;
signed int(32) zMax;
}

xPosition, yPosition and zPosition is a 16.16 fixed-point value in suitable units that specifies the position in 3D space with (0,0,0) as the center of the global co-ordinate system.
xPosition shall be in the range of xMin and xMax, inclusive.
yPosition shall be in the range of yMin and yMax, inclusive.
zPosition shall be in the range of zMin and zMax, inclusive.
xMin, yMin and zMin is a 16.16 fixed-point value in suitable units that specifies the minimum value of X, Y, Z co-ordinates respectively in the global co-ordinate system corresponding to 3D region specified by this structure.
xMax, yMax and zMax is a 16.16 fixed-point value in suitable units that specifies the maximum value of X, Y, Z co-ordinates respectively in the global co-ordinate system corresponding to 3D region specified by this structure.
If limits_flag is equal to 0 the values of xMin, yMin, zMin, are each inferred to be equal to 0 and xMax, yMax and zMax are each inferred to be equal to 1.
In a variant example: If limits_flag is equal to 1 xPosition shall be in the range of xMin and xMax, inclusive.

In another variant, the VRBB( ) structure may be as shown below, with semantics as defined before.

aligned(8) class VRBB() {

unsigned int(32) xMin;
unsigned int(32) xMax;
unsigned int(32) yMin;
unsigned int(32) yMax;
unsigned int(32) zMin;
unsigned int(32) zMax;
}

Further, it should be noted that with respect to the semantics above, in another example:
   If limits_flag is equal to 1 xPosition shall be in the range of xMin and xMax, inclusive.
   If limits_flag is equal to 1 yPosition shall be in the range of yMin and yMax, inclusive.
   If limits_flag is equal to 1 zPosition shall be in the range of zMin and zMax, inclusive.

In one example, according to the techniques described herein, data encapsulator 107 may be configured to signal position information as a set of Euler angles and a radial distance. For example, data encapsulator 107 may be configured to signal position information based on the following example definition, syntax, and semantics:

### Definition

The position structure (DPositionStruct) specifies position information.

Syntax

aligned(8) DPositionStruct( ) {

signed int(32) positionAzimuth;
signed int(32) positionElevation;
signed int(32) positionTilt;

float distance;

}

Semantics
positionAzimuth, positionElevation and positionTilt respectivly specify the azimuth, elevation and tilt angles of the position point in 3D space with (0,0,0) as the center of the global co-ordinate system.
positionAzimuth shall be in the range of −180*2¹⁶ to 180*2¹⁶−1, inclusive.
positionElevation shall be in the range of −90*2¹⁶ to 90*2¹⁶, inclusive.
positionTilt shall be in the range of −180*2¹⁶ to 180*2¹⁶−1, inclusive.
distance specifies the distance along the vector from (0,0,0) in suitable units to the point defined by positionAzimuth, positionElevation and positionTilt in 3D space corresponding to the indicated position in the 3D space.

In one example, according to the techniques described herein, data encapsulator 107 may be configured to signal position information by augmenting a sphere region structure by a radial distance and constraining a sphere region by requiring range_included_flag to be zero for position indication. For example, data encapsulator 107 may be configured to signal position information based on the following example definition, syntax, and semantics:

### Definition

The position structure (RPositionStruct) specifies position information.

Syntax

aligned(8) RPositionStruct( ) {

SphereRegionStruct(0)

```
  float distance;
  }
```

Semantics

distance specifies the distance along the vector from (0,0,0) in suitable units to the point defined by center_azimuth, center_elevation and center_tilt in 3D space corresponding to the indicated position in the 3D space.

It should be noted that in the above example, instead of using a data type of float for the syntax element “distance”, a fixed point data type may be used. In this case in one example the syntax and semantics for distance may be as follows:

unsigned int(32) distance;

distance is a 16.16 fixed-point value in suitable units which specifies the distance along the vector from (0,0,0) to the point defined by center_azimuth, center_elevation and center_tilt in 3D space corresponding to the indicated position in the 3D space.

In another, example a syntax element interpolate may be added to the PositionStruct, RPositionStruct, and/or DPositionStruct). For example, interpolate may be added to the PositionStruct based on the following syntax:

Syntax

aligned(8) PositionStruct(limits_flag) {

unsigned int(32) xPosition;
unsigned int(32) yPosition;
unsigned int(32) zPosition;
unsigned int(1) interpolate;
bit(7) reserved = 0;
if (limits_flag) {

unsigned int(32) xMin;
unsigned int(32) xMax;
unsigned int(32) yMin;
unsigned int(32) yMax;
unsigned int(32) zMin;
unsigned int(32) zMax;

}

}

In one example, the semantics of interpolate may be based on the following semantics:

Semantics

interpolate equal to 0 specifies that the values of xPosition, yPosition, zPosition, in this sample apply to the target media samples. interpolate equal to 1 specifies that the values of xPosition, yPosition, zPosition, that apply to the target media samples are linearly interpolated from the values of the corresponding fields in this sample and the previous sample.

In one example, according to the techniques described herein, data encapsulator 107 may be configured to signal position information based on the following example definition, syntax, and semantics, where an additional flag may control if the (X, Y, Z) point position is signaled in the position structure:

### Definition

The position structure (PositionStruct) specifies a position information and position limits information.
If xMin, xMax, yMin, yMax, zMin, zMax are all equal to 0, the structure specifies a point in 3D space.
Otherwise, the structure specifies a region in 3D space with an anchor position in that 3D region.
If xPosition, yPosition, and zPosition is unspecified then the structure specifies a region (or space) in 3D space.

Syntax

aligned(8) PositionStruct(position_flag, limits_flag) {

if (positions_flag) {;
unsigned int(32) xPosition;
unsigned int(32) yPosition;
unsigned int(32) zPosition;
}
if (limits_flag)

VRBB( )

}
aligned(8) class VRBB( ) {

signed int(32) xMin;
signed int(32) xMax;
signed int(32) yMin;
signed int(32) yMax;
signed int(32) zMin;
signed int(32) zMax;
}

Semantics

xPosition, yPosition and zPosition is a 16.16 fixed-point value in suitable units that specifies the position in 3D space with (0,0,0) as the center of the global co-ordinate system.

xPosition shall be in the range of xMin and xMax, inclusive. yPosition shall be in the range of yMin and yMax, inclusive. zPosition shall be in the range of zMin and zMax, inclusive.

xMin, yMin and zMin is a 16.16 fixed-point value in suitable units that specifies the minimum value of X, Y, Z co-ordinates respectively in the global co-ordinate system corresponding to 3D region specified by this structure.

xMax, yMax and zMax is a 16.16 fixed-point value in suitable units that specifies the maximum value of X, Y, Z co-ordinates respectively in the global co-ordinate system corresponding to 3D region specified by this structure.

If limits-flag is equal to 0 the values of xMin, yMin, zMin, are each inferred to be equal to 0 and xMax, yMax and zMax are each inferred to be equal to 1.

In one example if position_flag is equal to 0 the values of xMin, yMin, zMin, are each inferred to be unspecified.

In one example if position_flag is equal to 0 the values of xMin, yMin, zMin, are each inferred to be equal to 0.

It should be noted that with respect to the semantics described above, suitable units may include one of: meters, centimeters, or millimeters and the semantics may correspond to a local coordinate system instead of a global coordinate system.

Data encapsulator 107 may be configured to signal position information according to a file format position box having the following example definition and syntax:

### Definition

Box Type: ‘posn’

Container: ProjectedOmniVideoBox

Mandatory: No

Quantity: Zero or one

The fields in this box provides the X, Y, and Z values which specify translation to be applied to convert the local coordinate axes to the global coordinate axes. In the case of stereoscopic omnidirectional video, the fields apply to each view individually. When the PositionBox is not present, the fields xPosition, yPosition, and zPosition are all inferred to be equal to 0.

Syntax

aligned(8) class PositionBox extends FullBox(‘posn’,
0, 0) {

PositionStruct(0);

}

In another example for the above box some other container than ProjectedOmniVideoBox may be used as Container. Also the Quantity for this box may instead be as follows:

Quantity: Zero or more

Data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

The (xMin, yMin and zMin) and (xMax, yMax and zMax) values in this box specify the bounding box (X, Y, Z) minimum and maximum co-ordinates which specify the 3D space within which an immersive VR experience is supported.

Syntax

aligned(8) class ViewingSpaceBox extends FullBox(‘vssn’,
0, flags) {

VRBB( );

}

In another example, data encapsulator 107 may be configured to signal position information according to a file format position box having the following example definition and syntax, where in addition to the viewing space bounding box a preferred viewing position is signaled in this ISOBMFF box:

### Definition

Box Type: ‘vssn’

Container: ProjectedOmniVideoBox

Mandatory: No

Quantity: Zero or one

The (xMin, yMin and zMin) and (xMax, yMax and zMax) values in this box specify the bounding box (X, Y, Z) minimum and maximum co-ordinates which specify the 3D space within which an immersive VR experience is supported.

Syntax

aligned(8) class ViewingSpaceBox extends FullBox(‘vssn’,
0, flags) {
Positionstruct(1);
}

In one example, in the case where an additional flag controlling if the (X, Y, Z) point position is signaled in the position structure, data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

The (xMin, yMin and zMin) and (xMax, yMax and zMax) values in this box specify the bounding box (X, Y, Z) minimum and maximum co-ordinates which specify the 3D space within which an immersive VR experience is supported.

Syntax

aligned(8) class ViewingSpaceBox extends FullBox(‘vssn’,
0, flags) {

Positionstruct(0,1);

}

In another example, data encapsulator 107 may be configured to signal position information according to a file format position box having the following example definition and syntax, where the viewing space box may be defined by setting both position_flag and limits_flag to 1 as follows:

### Definition

Box Type: ‘vssn’

Container: ProjectedOmniVideoBox

Mandatory: No

Quantity: Zero or one

The (xMin, yMin and zMin) and (xMax, yMax and zMax) values in this box specify the bounding box (X, Y, Z) minimum and maximum co-ordinates which specify the 3D space within which an immersive VR experience is supported.

Syntax

aligned(8) class ViewingSpaceBox extends FullBox(‘vssn’,
0, flags) {

Positionstruct(1,1);

}

In another example, all occurrences above for ‘vssn’ box quantity may instead be

Quantity: Zero or more

instead of

Quantity: Zero or one

In another example all occurrences above for ‘vssn’ box quantity may instead be

Quantity: Zero or more

instead of

Quantity: one

In another example instead of ‘vssn’ the box may be called as ‘vspc’ or ‘vspa’ or some other name.

In another example instead of the Container for the box being ProjectedOmniVideoBox some other container for example VisualSampleEntry may be used.

As described above, MPEG-I includes an initial viewing orientation metadata. In one example, position information signaling may be used to augment the signaling of initial viewing orientation and position. For example, data encapsulator 107 may be configured to signal initial viewing orientation metadata having the following definition, syntax and semantics:

### Definition

This metadata indicates initial viewing orientations and position that should be used when playing the associated media tracks or a single omnidirectional image stored as an image item. In the absence of this type of metadata centre_azimuth, centre_elevation, and centre_tilt should all be inferred to be equal to 0 and xPosition, yPosition and zPosition should all be inferred to be equal to 0.

An OMAF player should use the indicated or inferred centre_azimuth, centre_elevation, and centre_tilt values as follows:
If the orientation/viewport metadata of the OMAF player is obtained on the basis of an orientation sensor included in or attached to a viewing device, the OMAF player should
   obey only the centre_azimuth value, and
   ignore the values of centre_elevation and centre_tilt and use the respective values from the orientation sensor instead.
   and obey xPosition, yPosition and zPosition values.
Otherwise, the OMAF player should obey all three of centre_azimuth, centre_elevation, and centre_tilt and xPosition, yPosition and zPosition values.

The track sample entry type ‘initial viewing position’ (e.g. ‘invp’) shall be used.

shape_type shall be equal to 0, dynamic_range_flag shall be equal to 0, static_azimuth_range shall be equal to 0, and static_elevation_range shall be equal to 0 in the SphereRegionConfigBox of the sample entry.
NOTE: This metadata applies to any viewport regardless of which azimuth and elevation ranges are covered by the viewport. Thus, dynamic_range_flag, static_azimuth_range, and static_elevation_range do not affect the dimensions of the viewport that this metadata concerns and are hence required to be equal to 0. When the OMAF player obeys the centre_tilt value as concluded above, the value of centre_tilt could be interpreted by setting the azimuth and elevation ranges for the sphere region of the viewport equal to those that are actually used in displaying the viewport.

Syntax

class InitialViewingOrientationPositionSample( ) extends

SphereRegionSample ( ) {

PositionStruct(0);
unsigned int(1) refresh_flag;
bit(7) reserved = 0;

}

Semantics

refresh_flag equal to 0 specifies that the indicated viewing orientation and/or viewing position signaled by PositionStruct(0) should be used when starting the playback from a time-parallel sample in an associated media track. refresh_flag equal to 1 specifies that the indicated viewing orientation and/or viewing position signaled by PositionStruct(0) should always be used when rendering the time-parallel sample of each associated media track, i.e., both in continuous playback and when starting the playback from the time-parallel sample.
NOTE 2: refresh_flag equal to 1 enables the content author to indicate that a particular viewing orientation and/or viewing position is recommended even when playing the video continuously. For example, refresh_flag equal to 1 could be indicated for a scene cut position.

In one example, a user's VR space may be automatically calibrated and setup by setting the user's initial position as the signaled initial viewing orientation and position.

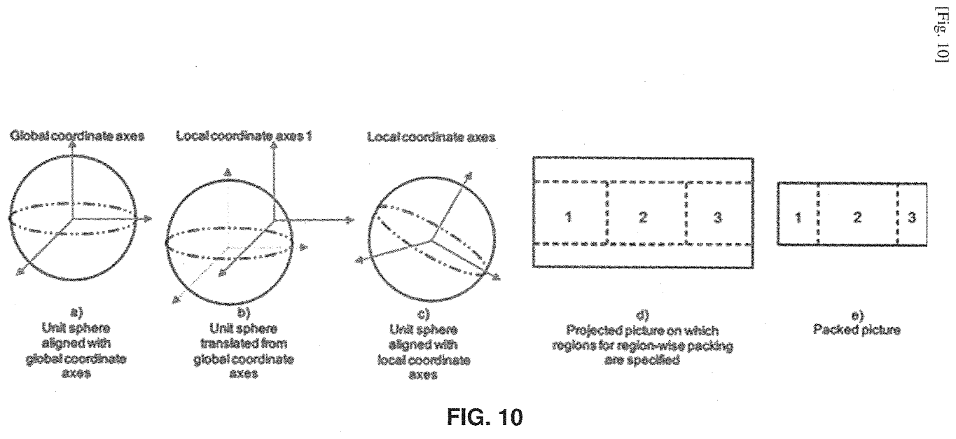

MPEG-I provides an informative section describing the relation of decoded pictures to global coordinate axes. That is, MPEG-I provides an ordered process that could be used for content authoring and an ordered process for mapping sample locations of a packed picture to a unit sphere used for content rendering. In cases where the signaling of position information is enabled, the unit sphere may be translated relative to the global coordinate axes for content authoring. That is, the amount of translation may be specified by the X, Y, Z values indicated in the PositionBox. In this cases, the center of local coordinate axes is thus, translated with respect to the center of the global coordinate axes. In one example, the absence of PositionBox may indicate that the local coordinate axes center is the same as the global coordinate axes center. Further, for content rendering, if translation is indicated, the cartesian coordinates relative to the local coordinate axes may be converted to cartesian coordinates relative to the global coordinate axes. Otherwise, if translation is not indicated, the center of global coordinate axes are identical to the center of local coordinate axes. In this case, FIG. 10 illustrates the conversions from a spherical picture to a packed picture that could be used in content authoring and the corresponding conversions from a packed picture to a spherical picture to be rendered that could be used in an OMAF player. The additional step described above is shown in part b) of FIG. 10.

In one example, according to the techniques described herein, the translation of the center from the local coordinate axes to the global coordinate axes may be as follows:
Inputs to this process are:
   xPosition, yPosition, zPosition, and
   cartesian coordinates (x, y, z) relative to the local coordinate axes. Outputs of this process are:
   cartesian coordinates (x′, y′, z′) in degrees relative to the global coordinate axes.

This process specifies translation of the center of the coordinate system.

When any of the xPosition, yPosition, zPosition is not equal to zero, a player needs to apply the translation process specified in this clause to convert the center of local coordinate axes to the center of global coordinate axes.

It is assumed that the center of global coordinate systems for different media types were made aligned during content production.

The outputs are derived as follows:
x′=x+xPosition
y′=y+yPosition
z′=z+zPosition
In an alternative example the outputs may be derived as follows:
x′=x−xPosition
y′=y−yPosition
z′=z−zPosition

In one example, according to the techniques described herein, data encapsulator 107 may be configured to signal an immersive experience space. For example, data encapsulator 107 may be configured to signal immersive VR boundaries based on the following example definition, syntax, and semantics:

### Definition

The 3D space where the user can get immersive VR experience may be limited in 3DOF+ or 6 DOF or video with parallax application. The Immersive VR boundaries timed metadata track indicates the VR space boundaries where immersive experience is supported. The space can be static or can change dynamically on sample basis. A bounding box indicates the limits of the immersive VR space. Certain spaces within the bounding box could be indicated as excluded spaces for VR experience. For example, the space within the environment which corresponds to the camera/microphone capture equipment may be marked as excluded space within the overall immersive VR space. In other examples, the excluded space signaling can be used if the immersive VR experience is provided in non-rectangular prism/cuboid. There may be application/tracking equipment specific reasons for excluded spaces.

In another example, the 3D space where the user can get immersive VR experience may be defined as a viewing space as follows:

Viewing space is 3D space of viewing positions within which rendering of image and video is enabled and VR experience is valid.

The viewing space may change in time, i.e., it may be dynamic and may be as such the information about it signaled with dynamic metadata.

For example, a Viewing Space may enable immersive experience for the following viewing situations:
A user sitting on a couch or a rotating chair in a natural way.
A user standing in a natural way but without taking steps.
A user sitting in a rotating chair

Also, a Viewing Space may contain viewing positions constrained to head motion movements.

Syntax and Semantics

The track sample entry type ‘vrsp’ shall be used.

The sample entry of this sample entry type is specified as follows:

class VRSpaceSampleEntry(type) extends MetadataSampleEntry(‘vrsp’) {

unsigned int(1) static_vr_space_flag;
unsigned int(1) vr_space_exclusions_info_present_flag;
if (vr_space_exclusions_info_present_flag == 1) {

unsigned int(1) static_vr_exclusions_flag;
bit(5) reserved = 0;

}
else {

bit(6) reserved = 0;

}
if (static_vr_space_flag == 1) {

VRBB(0)

```
  }
if (vr_space_exclusions_info_present_flag == 1) {
  if (static_vr_exclusions_flag == 1) {
```

unsigned int(8) static_num_excluded_regions_minus1;
for (i = 1; i <= static_num_excluded_regions_minus1+1; i++)
VRBB(i)

}
}

}
aligned(8) class VRBB(i) {

signed int(32) xMin[i];
signed int(32) xMax[i];
signed int(32) yMin[i];
signed int(32) yMax[i];
signed int(32) zMin[i];
signed int(32) zMax[i];
}

static_vr_space_flag equal to 1 specifies that the immersive VR experience space does not change for each sample referring to this sample entry. static_vr_space_flag equal to 0 specifies that the immersive 3D VR space may change for samples referring to this sample entry.

vr_space_exclusions_info_present_flag equal to 1 specifies that the immersive VR experience space includes excluded areas where immersive VR experience is not supported within the bounding box VRBB(0) for immersive VR experience. vr_space_exclusions_info_present_flag equal to 0 specifies that the immersive VR experience space does not include any excluded areas within the bounding box VRBB(0) for immersive VR experience.

When vr_space_exclusions_info_present_flag is equal to 1 static_vr_exclusions_flag is signaled. When vr_space_exclusions_info_present_flag is equal to 0 static_vr_exclusions_flag is not signaled.

static_vr_exclusions_flag equal to 1 specifies that the space excluded from immersive VR experience does not change for each sample referring to this sample entry. static_vr_exclusions_flag equal to 0 specifies that the space excluded from immersive VR experience may change for samples referring to this sample entry. When not present static_vr_exclusions_flag is inferred to be equal to 1.

VRBB(0) in the sample entry specifies the bounding box (X, Y, Z) minimum and maximum co-ordinates which specify the 3D space within which excluding any signaled excluded VR space areas an immersive VR experience is supported.

static_num_excluded_regions_minus1 plus 1 specifies the number of VRBB(i) structures signaled in the sample entry which indicate the number of excluded spaces from the immersive VR experience.

VRBB(i) for i greater than 0 in the sample entry specifies the bounding box (X, Y, Z) minimum and maximum co-ordinates which specify the 3D space in the 3D space specified by VRBB(0) within which an immersive VR experience is not supported. It is a requirement of conformance that each of VRBB(i) for i greater than 0 shall be within the 3D space specified by VRBB(0).

aligned(8) VRspaceSample( ) {

if(static_vr_space_flag == 0)

VRBB(0)

if (vr_space_exclusions_info_present_flag == 1) {
if (static_vr_exclusiong_flag == 0) {

unsigned int(8) num_excluded_regions_minus1;
for (i = 1; i <= num_excluded_regions_minus1+1; i++)
VRBB(i)

}
}

}

The sample syntax shown in VRspaceSample shall be used.

VRBB(0) in the sample specifies the bounding box (X, Y, Z) minimum and maximum co-ordinates which specify the 3D space within which excluding any signaled excluded VR space areas an immersive VR experience is supported for the associated media track samples.

num_excluded_regions_minus1 plus 1 specifies the number of VRBB(i) structures signaled in the sample which indicate the number of excluded spaces from the immersive VR experience.

VRBB(i) for i greater than 0 in the sample specifies the bounding box (X, Y, Z) minimum and maximum coordinates which specify the 3D space in the 3D space specified by VRBB(0) within which an immersive VR experience is not supported for the associated media track samples. It is a requirement of conformance that each of VRBB(i) for i greater than 0 shall be within the 3D space specified by VRBB(0) In one example, data encapsulator 107 may be configured to signal viewing space box for ISOBMFF based on the following example definition, syntax, and semantics:

### Definition

Box Type: ‘vssn’

### Container: ProjectedOmniVideoBox

### Mandatory: No

### Quantity: Zero or one

The fields in this box specify 3D viewing space within which an immersive VR experience is provided.

Syntax

aligned(8) class ViewingSpaceBox extends FullBox(‘vssn’,
0, flags) {

unsigned int(1) vr_space_exclusions_info_present_flag; ;
bit(7) reserved = 0;
VRBB(0);
if (vr_space_exclusions_info_present_flag == 1) {

unsigned int(8) num_excluded_regions_minus1;

for (i = 1; i <= num_excluded_regions_minus1+1; i++)
VRBB(i)

}

}

Semantics

VRBB(0) specifies the bounding box (X, Y, Z) minimum and maximum co-ordinates which specify the 3D viewing space within which excluding any signaled excluded VR space areas an immersive VR experience is supported.

vr_space_exclusions_info_present_flag equal to 1 specifies that the immersive VR experience space includes excluded areas where immersive VR experience is not supported within the bounding box VRBB(0). vr_space_exclusions_info_present_flag equal to 0 specifies that the immersive VR experience space does not include any excluded areas within the bounding box VRBB(0).

num_excluded_regions_minus1 plus 1 specifies the number of VRBB(i) structures signaled which indicate the number of excluded spaces from the immersive VR experience.

VRBB(i) for i greater than 0 specifies the bounding box (X, Y, Z) minimum and maximum co-ordinates which specify the 3D space in the 3D space specified by VRBB(0) within which an immersive VR experience is not supported. It is a requirement of conformance that each of VRBB(i) for i greater than 0 shall be within the 3D space specified by VRBB(0).

In another example, one or more VRBB(0) and/or VRBB(i) structures in the above description may be replaced with PositionStruct(0) or PositionStruct(1) or PositionStruct(1,1) or PositionStruct(0,1), or PositionStruct(1,0).

In another example some of the above semantics may be as follows:

VRBB(0) specifies the bounding box (X, Y, Z) minimum and maximum co-ordinates which specify the 3D viewing space range.

vr_space_exclusions_info_present_flag equal to 1 specifies that the immersive VR experience space includes excluded areas where immersive VR experience is not supported within the viewing space. vr_space_exclusions_info_present_flag equal to 0 specifies that the immersive VR experience space does not include any excluded areas within the viewing space.

num_excluded_regions_minus1 plus 1 specifies the number of VRBB(i) structures signaled which indicate the number of excluded spaces from the viewing space.

VRBB(i) for i greater than 0 specifies the bounding box (X, Y, Z) minimum and maximum co-ordinates which specify the 3D space in the viewing space specified by VRBB(0) within which an immersive VR experience is not supported. It is a requirement of conformance that each of VRBB(i) for i greater than 0 shall be within the 3D space specified by VRBB(0).

Further, data encapsulator 107 may be configured to signal additional information that may be specified for the immersive VR experience space which may be called viewing space and/or spaces corresponding to the excluded regions. For this, in one example, a list of one or more track identifier (track_id) values associated with the immersive VR experience space and/or spaces corresponding to the excluded regions may be signaled. This linking of the immersive VR experience space and/or spaces corresponding to the excluded regions to one or more tracks then allows signaling of any relevant characteristics of the samples associated with those spaces using ISOBMFF defined mechanisms (e.g. sample entry/other timed metadata tracks associated with the referred track etc.). In one example, the association may be defined as: the associated/referred track includes the content corresponding to the immersive VR experience space and/or spaces corresponding to the excluded regions. In one example, a flag may be signaled to indicate, if the association of immersive VR experience space and/or spaces corresponding to the excluded regions with the tracks is signaled. In one example the information may be signaled as follows:

Syntax and Semantics

class VRSpaceSampleEntry(type) extends
MetadataSampleEntry(‘vrsp’) {

unsigned int(1) static_vr_space_flag;
unsigned int(1) vr_space_exclusions_info_present_flag;
unsigned int(1) vr_space_track_association_info_present_flag;
if (vr_space_exclusions_info_present_flag == 1) {

unsigned int(1) static_vr_exclusions_flag;
bit(4) reserved = 0;

}
else {

bit(6) reserved = 0;

}
if (static_vr_space_flag == 1) {

VRBB(0)

```
  }
if (vr_space_exclusions_info_present_flag == 1) {
  if (static_vr_exclusions_flag == 1) {
```

unsigned int(8) static_num_excluded_regions_minus1;
for (i = 1; i <= static_num_excluded_regions_minus1+1; i++)
VRBB(i)

}
}

}
aligned(8) class VRBB(i) {

signed int(32) xMin[i];
signed int(32) xMax[i];
signed int(32) yMin[i];
signed int(32) yMax[i];
signed int(32) zMin[i];
signed int(32) zMax[i];
if(vr_space_track_association_info_present_flag){

```
    unsigned int(8) num_track_ids_minus1;
    for (i = 0; i <= num_track_ids_minus1; i++) {
```

unsigned int(32) assoc_track_IDs[i];

}

}

vr_space_track_association_info_present_flag equal to 1 specifies that track ID information associated with the immersive VR experience space and/or excluded region spaces is signaled in VRBB(i). vr_space_track_association_info_present_flag equal to 0 specifies that track ID information associated with the immersive VR experience space and/or excluded region spaces is not signaled in VRBB(i). num_track_ids_minus1 plus 1 specifies the number of assoc_track_IDs signaled. assoc_track_IDs is an array of unsigned 32 bit integers providing the track identifiers of the referenced tracks which correspond to the immersive VR experience space and/or excluded region spaces. Each value in the assoc_track_IDs shall be unique. The value 0 is reserved.

In another example, instead of signaling num_track_ids_minus1, and assoc_track_IDs[i] in VRBB(i), one or more of those syntax elements may be directly signaled in the sample entry (e.g. VRSpaceSampleEntry) and/or in the sample (e.g. VRspaceSample( )) outside of the VRBB(i).

In another example, one or more VRBB(0) and/or VRBB(i) structures in the above description may be replaced with PositionStruct(0) or PositionStruct(1) or PositionStruct(1,1) or PositionStruct(0,1), or PositionStruct(1,0). For example the ViewingSpaceBox described above may be defined as:

aligned(8) class ViewingSpaceBox extends
FullBox(‘vssn’, 0, flags) {

unsigned int(1) vr_space_exclusions_info_present_flag; ;
bit(7) reserved = 0;
PositionStruct(1)[0];
if (vr_space_exclusions_info_present_flag == 1) {

unsigned int(8) num_excluded_regions_minus1;

for (i = 1; i <= num_excluded_regions_minus1+1; i++)
PositionStruct(1)[i]

}

}

In one example, the expected operation of a OMAF player using indicated immersive VR space boundaries may be as follows:
The user position at any given time is obtained from a position tracking sensor and/or is known through other external means. The user position is indicated as (X, Y, Z)
The signaled values of VRBB(i) for i=0 and i>0 are parsed from the VRSpaceSampleEntry and/or VRSpaceSample.
The OMAF player may make a determination about the current user position into one of the following categories:
   User position is outside the immersive VR experience space indicated by VRBB(0):
In this case the OMAF player is expected to not provide an immersive experience. The OMAF player may choose to display a warning or other visual/audible indications which may indicate to the user that no immersive experience is provided since the user has moved out of the space/position where the content supports immersive experience. Additionally the user may be provided indication of how to return to the space where immersive VR experiences is provided.
   User position is inside the immersive VR experience space and is outside excluded region spaces indicated by VRBB(o) for each o>1.
In this case the OMAF player is expected to provide the rendering and immersive experience as provided by the content creator based on the current position of the user.
   User position is inside the immersive VR experience space indicated by VRBB(0) but is inside an excluded region e indicated by VRBB(e)
In this case, if the excluded space the user is located in has information regarding associated tracks, then the OMAF player is expected to parse those tracks and follow the rendering operation based on the sample entry, samples and any associated metadata for those tracks.
If the excluded space the user is located in does not have information regarding associated tracks, then the OMAF player may choose to display a warning or other visual/audible indications which may indicate to the user that no immersive experience is provided since the user has moved out of the position which is excluded from the user's immersive experience.

In one example, according to the techniques described herein, data encapsulator 107 may be configured to signal multiple labelled viewpoint positions. For example, data encapsulator 107 may be configured to user viewpoint position information based on the following example definition, syntax, and semantics:

### Definition

The user viewpoint position timed metadata track indicates the position in 3D space that the user is recommended to be at and optionally the recommended orientation at the position. Depending upon the application either the user may be directed to physically move to the recommended position or alternatively the VR scene may be rendered considering the current user position to be at the recommended position and orientation at the time. In the latter case some scene transition effects may be performed if/when changing user position from time to time.

Syntax and Semantics

The track sample entry type ‘usvp’ shall be used.

The sample entry of this sample entry type is specified as follows:

class UsvpSampleEntry(type) extends
MetadataSampleEntry(‘usvp’) {

string userposition_label;

}
userposition_label is a null-terminated UTF-8 string that provides

a textual description of the user viewpoint position.

The sample syntax shown in UsvpSample shall be used.
aligned(8) UsvpSample( ) {

PositionStruct(0);
unsigned int(1) orientation_flag;
bit(7) reserved = 0;

if(orientation_flag) {

SphereRegionStruct(0);

}

}

xPosition, yPosition and zPosition in the PositionStruct indicate the recommended (X, Y, Z) user viewpoint position in the 3D space in the local coordinate axes.

In an example, xPosition, yPosition and zPosition in the PositionStruct indicate the recommended (X, Y, Z) user viewpoint position in the 3D space in the global coordinate axes.

In another example, the limits_flag may be allowed to be equal to 1 or 0 in the PositionStruct. In this case, if limits_flag is equal to 1, xMin, yMin, zMin, xMax, yMax and zMax represent the extent of X, Y, Z coordinates in the local coordinate axes that the user is allowed to move while providing immersive VR experience. If limits_flag is equal to 0 the values of xMin, yMin, zMin, xMax, yMax and zMax, are inferred to be equal to the corresponding values in the previous sample. When limits_flag is equal to 0 in each sample (i.e no xMin, yMin, zMin, xMax, yMax and zMax values are signaled) in this timed metadata track, xMin, yMin, zMin, are each inferred to be equal to 0 and xMax, yMax and zMax are each inferred to be equal to 1.

Orientation_flag equal to 1 specifies that a SphereRegionStruct(0) syntax structure immediately follows this flag. Orientation_flag equal to 0 specifies that a SphereRegionStruct(0) syntax structure does not follow this flag and the recommended orientation parameters at this viewpoint are inferred as follows: centre_azimuth, centre_elevation, centre_tilt, are all inferred to be equal to 0. Additionally shape_type is inferred to be equal to 0, azimuth_range and elevation_range are both inferred to be equal to 0 and interpolate is inferred to be equal to 0.

When Orientation_flag equal to 1:

shape_type shall be equal to 0 in the SphereRegionConfigBox of the sample entry.

static_azimuth_range and static_elevation_range, when present, or azimuth_range and elevation_range, shall be each equal to 0.

centre_azimuth, centre_elevation and center_tilt indicate the recommended viewing orientation at the position indicated by the PositionStruct.

In another example, either the recommended user position and/or recommended user orientation may be static and can be signaled in the sample entry. For example, data encapsulator 107 may be configured to signal user viewpoint position information based on the following example syntax and semantics:

Syntax and Semantics

class UsvpSampleEntry(type) extends
MetadataSampleEntry(‘usvp’) { ;

```
string userposition_label;
unsigned int(1) static_position_flag;
unsigned int(1) static_orientation_flag;
bit(6) reserved = 0;
if(static_position_flag == 0)
  PositionStruct(0);
if(static_orientation_flag == 0)
  SphereRegionStruct(0);
}
```

static_position_flag equal to 1 specifies that xPosition, yPosition and zPosition in the PositionStruct in the sample entry indicate the recommended (X, Y, Z) user viewpoint position in the 3D space in the local coordinate axes for all the samples. static_position_flag equal to 0 specifies that the PositionStruct in the samples indicate the recommended (X, Y, Z) user viewpoint position in the 3D space in the local coordinate axes.

static_orientation_flag equal to 1 specifies that SphereRegionStruct in the sample entry indicates the recommended orientation for all the samples. static_orientation_flag equal to 0 SphereRegionStruct in the samples indicates the recommended orientation.

The sample syntax shown in UsvpSample shall be used.

aligned(8) UsvpSample( ) {

```
if(static_position_flag == 1)
  PositionStruct(0);
if(static_orientation_flag == 1)
  SphereRegionStruct(0);
```

}

In another example, the change in the recommended user position on sample-by-sample basis may be signaled as a relative change in the (X, Y, Z) positions compared to the previous sample.

In one example variant a flag may be signaled in the sample entry or sample to indicate if the signaled (X, Y, Z) position is absolute or relative to the previous sample. For example, according to the following syntax element:

unsigned int(1) relative_position_flag;

relative_position_flag equal to 1 specifies that xPosition, yPosition and zPosition in the PositionStruct in this sample indicates the recommended (X, Y, Z) user viewpoint position in the 3D space in the local coordinate axes as a difference compared to the recommended (X, Y, Z) user viewpoint position in the previous sample. relative_position_flag equal to 0 specifies that xPosition, yPosition and zPosition in the PositionStruct in this sample indicates absolute value of the recommended (X, Y, Z) user viewpoint position in the 3D space in the local coordinate axes.

In one example, in the case when using relative user position signaling fewer bits could be used to indicate xPosition, yPosition and zPosition values (all signaled with a data type of signed int).

In one example, the expected operation of a OMAF player using indicated multiple labelled user viewpoint positions may be as follows:
The OMAF player should parse one or more available timed metadata tracks sample entry type ‘usvp’ and parse the UsvpSampleEntry and the userposition_label in each of them.
The OMAF player may choose to display the list of available user viewpoint positions based on the parsed userposition_label strings from one or more timed metadata tracks above.
The user may be asked to choose a preferred viewpoint positions from the above list of available user viewpoint positions.
Based on the user selection, the OMAF player may choose to render the VR scene assuming the current user position to be at the position indicated by the sample data for the selected userposition_label and at the orientation indicated or inferred by the signaled orientation information.

It should be noted that in an example all or some occurrences of “3D space where an immersive VR experience is supported” may be replaced with “viewing space”. In another example, all or some occurrences of “3D space where an immersive VR experience is supported” may be replaced with “viewing space where VR experience is valid”.

In one example, according to the techniques described herein, data encapsulator 107 may be configured to signal viewing space information of a spherical space based on the following example definition, syntax, and semantics:

### Definition

The sphere space structure (SphereStruct) specifies information about a sphere.

Syntax

aligned(8) SphereStruct( ) {

unsigned int (32) radius;
}

Semantics

radius specifies the radius of a sphere in 3D space in suitable units with the center of the sphere at a reference point. Value 0 is reserved.

In one example, the above information may correspond to a local co-ordinate system. In a variant example the above information may correspond to a global co-ordinate system. In one example, the above information may correspond to some common reference coordinate system. For example, the common reference coordinate system may be common to multiple viewpoints. In one example, for the semantics above suitable units may be meters. In one example, for the semantics above the suitable units may be centimeters. In one example, for the semantics above the suitable units may be millimeters.

In one example, for the semantics above the suitable units may be in a scale which may be signaled according to the following syntax and semantics:

Syntax

aligned(8) class SphereStruct(scale) {

unsigned int (32) radius;

}

Semantics

radius specifies the radius of a sphere in 3D space in units where scale specifies number of units in one centimeter and with the center of the sphere at a reference point. Value 0 is reserved.

In one example, when the suitable units are in a scale, data encapsulator 107 may be configured to signal viewing space information of a spherical space based on the following example syntax, and semantics:

Syntax

aligned(8) class SphereStruct( ) {

unsigned int (16) scale;
unsigned int (32) radius;
}

### Semantics

scale specifies how many units correspond to 1 centimeter.

radius specifies the radius of a sphere in 3D space in suitable units where scale specifies the number of units in one centimeter, with the center of the sphere at a reference point. Value 0 is reserved.

In one example, a guard range space radius value may be signaled in the SphereStruct. The guard range space may correspond to a 3D space where the immersive VR experience is provided, but is not guaranteed to be optimal. Thus, the immersive VR experience may degrade gracefully (or gradually) in the guard range space. In one example, when a guard range radius value allowed to be signaled in the SphereStruct, data encapsulator 107 may be configured to signal viewing space information of a spherical space based on the following example syntax, and semantics:

Syntax

aligned(8) class SphereStruct( ) {

unsigned int (32) radius;
bit (1) guard_range_presence_flag;
bit (7) reserved;
if(guard_range_presence_flag)
unsigned int (16) guard_radius_diff;
}

Semantics

guard_range_presence_flag equal to 1 indicates that the information about guard range space is signalled via guard_radius_diff. guard_presence_flag equal to 0 indicates that the information about guard range space is not signaled and the guard range space may or may not be present.

guard_radius_diff specifies the thickness of the guard range space which is a spherical shell.

The guard range space corresponds to a spherical shell between outer sphere of radius equal to radius (i.e. the signaled syntax element) and inner sphere of radius equal to (radius-guard_radius_diff). guard_radius_diff shall be less than radius. guard_radius_diff equal to 0 indicates that the guard range space is not present and immersive VR experience is guaranteed in the sphere of radius equal to radius.

In one example, guard_radius_diff may be signaled as a percentage of radius.

In one example, guard_range_presence_flag may not be signaled and guard_radius_diff may be always signaled. In one example, this may be done when guard_radius_diff is signalled as a percentage of radius. In this case, the value 0 can indicate that the guard range space is not present and this signaling can save 8 bits, as shown according to the following syntax and semantics:

Syntax

aligned(8) class SphereStruct( ) {

unsigned int (32) radius;
unsigned int (8) guard_radius_diff;
}

### Semantics

guard_radius_diff specifies the thickness of the guard range space spherical shell inside the sphere of radius equal to radius as a percentage of the radius.
guard_radius_diff equal to 0 indicates that the guard range space is not present and immersive VR experience is guaranteed in the sphere of radius equal to radius.
guard_radius_diff shall be in the range of 0 to 100, inclusive. Value 101 to 255 are reserved.

In another example, 7 bits may be used for guard_radius_diff and one bit may be kept reserved as follows:

Syntax

aligned(8) class SphereStruct( ) {

unsigned int (32) radius;
bit (1) reserved;

unsigned int (7) guard_radius_diff;

}

In this case: guard_radius_diff shall be in the range of 0 to 100, inclusive. Value 101 to 127 are reserved. In one another example, the semantics of guard_radius_diff may be as follows:

guard_radius_diff specifies the thickness of the guard range space spherical shell inside the sphere of radius equal to radius as a percentage of the radius. guard_radius_diff equal to 0 indicates that the guard range space is not present and immersive VR experience is guaranteed in the sphere of radius equal to radius. guard_radius_diff equal to 101 indicates that the guard range space may or may not be present and information about the guard range space is not signaled. guard_radius_diff shall be in the range of 0 to 101, inclusive. Value 102 to 255 are reserved.

In one example, additionally the syntax element scale may be signaled along with the guard range space related syntax elements in the SphereStruct( ) structure.

Data encapsulator 107 may be configured to signal position information according to a file format position box having the following example definition and syntax:

### Definition

Box Type: ‘vssn’

### Container: ProjectedOmniVideoBox

### Mandatory: No

### Quantity: Zero or one

The radius in this box in the SphereStruct( ) specifies the sphere which specifies the 3D viewing space surrounding the viewer (or user).

Syntax

aligned(8) class ViewingSpaceBox extends
FullBox(‘vssn’, 0, flags) {

SphereStruct( ),

}

In one example, according to the techniques described herein, data encapsulator 107 may be configured to signal viewing space information of an ellipsoid space based on the following example definition, syntax, and semantics:

### Definition

The ellipsoid space structure (EllipsoidStruct) specifies information about an ellipsoid.

Syntax

aligned(8) class EllipsoidStruct( ) {

unsigned int (32) radiusX;
unsigned int (32) radiusY;
unsigned int (32) radiusZ;
}

Semantics

radiusX, radiusY, radiusZ specifies respectively the semiaxes lengths in X, Y and Z of an ellipsoid in 3D space in suitable units with the center of the ellipsoid at a reference point. Value 0 is reserved.

In one example, the above information may correspond to a local co-ordinate system. In a variant example the above information may correspond to a global co-ordinate system. In one example, the above information may correspond to some common reference coordinate system. For example, the common reference coordinate system may be common to multiple viewpoints. In one example, for the semantics above suitable units may be meters. In one example, for the semantics above the suitable units may be centimeters. In one example, for the semantics above the suitable units may be millimeters.

In one example, the suitable units may be in a scale which may be signaled according to the following syntax and semantics:

Syntax

aligned(8) class EllipsoidStruct(scale) {

unsigned int (32) radiusX;
unsigned int (32) radiusY;
unsigned int (32) radiusZ;
}

### Semantics

radiusX, radiusY, radiusZ specifies respectively the semi-axes lengths in X, Y and Z of an ellipsoid in 3D space in suitable units where scale specifies number of units in one centimeter with the center of the ellipsoid at a reference point. Value 0 is reserved.

In one example, when the suitable units are in a scale data encapsulator 107 may be configured to signal viewing space information according to the following syntax and semantics:

Syntax

aligned(8) class EllipsoidStruct( ) {

unsigned int (16) scale;
unsigned int (32) radiusX;
unsigned int (32) radiusY;
unsigned int (32) radiusZ;
}

Semantics

scale specifies how many units correspond to 1 centimeter.

radiusX, radiusY, radiusZ specifies respectively the semi-axes lengths in X, Y and Z of an ellipsoid in 3D space in suitable units where scale specifies the number of units in one centimeter, with the center of the ellipsoid at a reference point. Value 0 is reserved.

In one example, a guard range radius value may be signaled in the EllipsoidStruct. In one example, when a guard range radius value allowed to be signaled in the EllipsoidStruct, data encapsulator 107 may be configured to signal viewing space information of a spherical space based on the following example syntax, and semantics:

Syntax

aligned(8) class EllipsoidStruct( ) {

```
  unsigned int (32) radiusX;
  unsigned int (32) radiusY;
  unsigned int (32) radiusZ;;
  bit (1) guard_range_presence_flag;
  bit (7) reserved;
  if(guard_range_presence_flag) {
```

unsigned int (16) guard_radius_diffX;
unsigned int (16) guard_radius_diffY;
unsigned int (16) guard_radius_diffZ;

}
}

### Semantics

guard_range_presence_flag equal to 1 indicates that the information about guard range space is signalled via guard_radius_diff. guard_presence_flag equal to 0 indicates that the information about guard range space is not signalled and the guard range space may or may not be present.

guard_radius_diffX, guard_radius_diffY, guard_radius_diffZ respectively are used to specify the shape of the inner ellipsoid where the space between the inner and outer ellipsoid corresponds to the guard range space.

The guard range space is the space between outer ellipsoid with semiaxes lengths in X, Y and Z radius equal to radiusX, radiusY, radiusZ respectively and inner ellipsoid with semiaxes lengths in X, Y and Z equal to (radiusX-guard_radius_diffX), (radiusY-guard_radius_diffY), (radiusZ-guard_radius_diffZ) respectively. guard_radius_diffX shall be less than radiusX. guard_radius_diffY shall be less than radiusY. guard_radius_diffZ shall be less than radiusZ.

When guard_radius_diffX, guard_radius_diffY, and guard_radius_diffZ are each equal to 0 indicates that the guard range space is not present and immersive VR experience is guaranteed in the ellipsoid signalled by radiusX, radiusY, radiusZ.

In one example guard_radius_diffX, guard_radius_diffY, and guard_radius_diffZ may be signaled as a percentage of radiusX, radiusY, and radius, respectively.

In one example guard_range_presence_flag, may not be signaled and guard_radius_diffX, guard_radius_diffY, and guard_radius_diffZ may be always signaled. This may be done when guard_radius_diffX, guard_radius_diffY, and guard_radius_diffZ are signaled as a percentage of radiusX, radiusY, and radiusZ respectively, as shown according to the following syntax and semantics:

Syntax

aligned(8) class EllipsoidStruct( ) {

unsigned int (32) radiusX;
unsigned int (32) radiusY;
unsigned int (32) radiusZ;;
unsigned int (8) guard_radius_diffX;
unsigned int (8) guard_radius_diffY;
unsigned int (8) guard_radius_diffZ;
}

### Semantics

guard_radius_diffX, guard_radius_diffY, guard_radius_diffZ respectively are used to specify the shape of the inner ellipsoid as a percentage value where the space between the inner and outer ellipsoid corresponds to the guard range space.

The guard range space is the space between outer ellipsoid with semi-axes lengths in X, Y and Z equal to radiusX, radiusY, radiusZ respectively and inner ellipsoid with semiaxes lengths in X, Y and Z equal to (radiusX*-guard_radius_diffX), (radiusY-guard_radius_diffY), (radiusZ-guard_radius_diffZ)) respectively. guard_radius_diffX shall be less than radiusX. guard_radius_diffXY shall be less than radiusY. guard_radius_diffZ shall be less than radiusZ.

In another example, 7 bits may be used for guard_radius_diffX, guard_radius_diffY, and guard_radius_diffZ and remaining bits may be kept reserved as follows:

Syntax

aligned(8) class EllipsoidStruct( ) {

unsigned int (32) radiusX;
unsigned int (32) radiusY;
unsigned int (32) radiusZ;
bit (1) reserved;
unsigned int (7) guard_radius_diffX;
bit (1) reserved;
unsigned int (7) guard_radius_diffY;
bit (1) reserved;
unsigned int (7) guard_radius_diffZ;
}

In this case: Each of guard_radius_diffX, guard_radius_diffY, and guard_radius_diffZ shall be in the range of 0 to 100, inclusive. Value 101 to 127 are reserved. In one example, the following semantics may be used:

guard_radius_diffX, guard_radius_diffY, guard_radius_diffZ respectively are used to specify the shape of the inner ellipsoid as a percentage value where the space between the inner and outer ellipsoid corresponds to the guard range space.

The guard range space is the space between outer ellipsoid with semi-axes lengths in X, Y and Z equal to radiusX, radiusY, radiusZ respectively and inner ellipsoid with semi-axes lengths in X, Y and Z equal to (radiusX*(100−guard_radius_diffX)/100), (radiusY*(100−guard_radius_diffY)/100), (radiusZ*(100−guard_radius_diffZ)/100) respectively. guard_radius_diffX, guard_radius_diffY, guard_radius_diffZ each shall be in the range of 0 to 100, inclusive. The value 101-255 are reserved.

In one example, the following semantics may be used:

The guard range space is the space between outer ellipsoid with semi-axes lengths in X, Y and Z equal to radiusX, radiusY, radiusZ respectively and inner ellipsoid with semi-axes lengths in X, Y and Z equal to (radiusX*(guard_radius_diffX)/100), (radiusY*(guard_radius_diffY)/100), (radiusZ*(guard_radius_diffZ)/100) respectively. guard_radius_diffX, guard_radius_diffY, guard_radius_diffZ each shall be in the range of 0 to 100, inclusive. The value 101-255 are reserved.

In another example, special values may be defined for guard_radius_diffX, guard_radius_diffY, guard_radius_diffZ as follows:

guard_radius_diffX, guard_radius_diffY, guard_radius_diffZ each equal to 0 indicates that the guard range space is not present and immersive VR experience is guaranteed in the ellipsoid with semiaxes lengths in X, Y and Z equal to radiusX, radiusY, radiusZ.

guard_radius_diffX, guard_radius_diffY, guard_radius_diffZ shall be in the range of 0 to 100, inclusive. Value 101 to 255 are reserved.

In one example, the following semantics may be used:

guard_radius_diffX, guard_radius_diffY, guard_radius_diffZ each equal to 0 indicates that the guard range space is not present and immersive VR experience is guaranteed in the ellipsoid with semiaxes lengths in X, Y and Z equal to radiusX, radiusY, radiusZ. guard_radius_diff equal to 101 indicates that the guard range may or may not be present and information about the guard range space is not signalled. guard_radius_diffX, guard_radius_diffY, guard_radius_diffZ shall be in the range of 0 to 101, inclusive. Value 102 to 255 are reserved.

In one example, additionally, the syntax element scale may be signaled along with the guard range space related syntax elements in the EllipsoidStruct( ) structure.

Data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

The radiusX, radiusY, radiusZ in this box in the EllipsoidStruct( ) specifies the ellipsoid which specifies the 3D viewing space surrounding the viewer (or user).

Syntax

aligned(8) class ViewingSpaceBox extends FullBox(‘vssn’,
0, flags) {

EllipsoidStruct( );

}

In one example, according to the techniques described herein, data encapsulator 107 may be configured to signal viewing space information of a cylinder space based on the following example definition, syntax, and semantics:

### Definition

The cylinder space structure (CylinderStruct) specifies information about a Cylinder.

Syntax

aligned(8) class CylinderStruct( )

unsigned int (32) radius;
Point(0);
Point(1);

}
aligned(8) class Point(i) {

unsigned int (32) x[i];

unsigned int (32) y[i];
unsigned int (32) z[i];
}

Semantics

radius specifies the radius of a cylinder in 3D space in suitable units with the cylinder formed around the line from Point(0) to Point(1). Value 0 is reserved.

X[i], y[i] and z[i] is a value in suitable units that specifies the X, Y, Z co-ordinates of a Point in 3D space with (0,0,0) as the center of the global co-ordinate system.

In one example, the above information may correspond to a local co-ordinate system. In a variant example the above information may correspond to a global co-ordinate system. In one example, the above information may correspond to some common reference coordinate system. For example, the common reference coordinate system may be common to multiple viewpoints. In one example, for the semantics above suitable units may be meters. In one example, for the semantics above the suitable units may be centimeters. In one example, for the semantics above the suitable units may be millimeters. In one example, for the semantics above the “suitable units” may be in a “scale” which is signaled.

In one example, according to the techniques described herein, data encapsulator 107 may be configured to signal viewing space information of a cylinder space based on the following example syntax and semantics:

Syntax

aligned(8) class CylinderStruct(scale) {

unsigned int (32) radius;
Point(0);
Point(1);

}

### Semantics

radius specifies the radius of a cylinder in 3D space in suitable units, where scale specifies number of units in one centimeter, with the cylinder formed around the line from Point(0) to Point(1). Value 0 is reserved.

In one example, according to the techniques described herein, data encapsulator 107 may be configured to signal viewing space information of a cylinder space based on the following example syntax and semantics:

Syntax

aligned(8) class CylinderStruct( ) {

unsigned int (16) scale;

unsigned int (32) radius;

Point(0);
Point(1);

}

Semantics

scale specifies how many units correspond to 1 centimeter.

radius specifies the radius of a cylinder in 3D space in suitable units, where scale specifies number of units in one centimeter, with the cylinder formed around the line from Point(0) to Point(1). Value 0 is reserved.

x[i], y[i] and z[i] is a value in suitable units that specifies the X, Y, Z co-ordinates of a Point in 3D space with (0,0,0) as the center of the global co-ordinate system.

In one example, a guard range radius value may be signaled in the CylinderStruct. The guard range space may correspond to a 3D space where the immersive VR experience is provided, but is not guaranteed to be optimal. Thus, the immersive VR experience may degrade gracefully in the guard range space. In one example, when a guard range radius value is allowed to be signaled in the CylinderStruct, data encapsulator 107 may be configured to signal viewing space information of a cylinder space based on the following example syntax and semantics:

Syntax

aligned(8) class CylinderStruct(scale) {

unsigned int (32) radius;
Point(0);
Point(1);
bit (1) guard_range_presence_flag;
bit (7) reserved;
if(guard_range_presence_flag)
unsigned int (16) guard_radius_diff;

}

### Semantics

guard_range_presence_flag equal to 1 indicates that the information about guard range space is signalled via guard_radius_diff. guard_presence_flag equal to 0 indicates that the information about guard range space is not signalled and the guard range space may or may not be present.

guard_radius_diff specifies the thickness of the guard range space which is a cylindrical shell.

The guard range space corresponds to a cylindrical shell between outer cylinder of radius equal to radius and inner cylinder of radius equal to (radius-guard_radius_diff). guard_radius_diff shall be less than radius. guard_radius_diff equal to 0 indicates that the guard range space is not present and immersive VR experience is guaranteed in the cylinder defined by Point(0), Point(1), and radius.

In one example, guard_radius_diff may be signaled as a percentage of radius.

In one example, guard_range_presence_flag may not be signalled and guard_radius_diff may be always signaled. In one example, this may be done when guard_radius_diff is signaled as a percentage of radius. In this case, the value 0 may indicate that the guard range space is not present and this signaling can save 8-bits. In one example, in this case, data encapsulator 107 may be configured to signal viewing space information of a cylinder space based on the following example syntax and semantics:

Syntax

aligned(8) class CylinderStruct( ) {

unsigned int (32) radius;
Point(0);
Point(1);

unsigned int (8) guard_radius_diff;
}

### Semantics

guard_radius_diff specifies the thickness of the guard range space cylindrical shell inside the cylinder of radius equal to radius as a percentage of the radius. guard_radius_diff equal to 0 indicates that the guard range space is not present and immersive VR experience is guaranteed in the cylinder defined by Point(0), Point(1), and radius.

guard_radius_diff shall be in the range of 0 to 100. Value 101 to 255 are reserved.

In another example, special values may be defined for guard_radius_diff as follows:

guard_radius_diff specifies the thickness of the guard range space cylindrical shell inside the cylinder of radius equal to radius as a percentage of the radius. guard_radius_diff equal to 0 indicates that the guard range space is not present and immersive VR experience is guaranteed in the cylinder defined by Point(0), Point(1), and radius. guard_radius_diff equal to 101 indicates that the guard range space may or may not be present and information about the guard range space is not signalled. guard_radius_diff shall be in the range of 0 to 101. Value 102 to 255 are reserved.

In one example, additionally the syntax element scale may be signaled along with the guard range space related syntax elements in the CylinderStruct( ) structure. In one example, the cylinder may be required to be constrained such that the axis of cylinder is parallel to one of the co-ordinate axis. As an example, the axis of the cylinder may be required to be parallel to X axis. As an example, the axis of the cylinder may be required to be parallel to Y axis. As an example, the axis of the cylinder may be required to be parallel to Z axis. As an example, one or more of the following constraints may be added:

It is a requirement of the bitstream conformance that x[0] shall be equal to x[1].

It is a requirement of the bitstream conformance that y[0] shall be equal to y[1].

It is a requirement of the bitstream conformance that z[0] shall be equal to z[1].

In one example instead of a circular cylinder defined by a single radius, an elliptical cylinder may be defined and used to signal viewing space. In this case, two syntax elements r1 and r2 which specify the semi-axes lengths will be signaled instead of a single radius syntax element.

Data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

The Point(0), Point(1), and radius in this box in the CylinderStruct( ) specifies the cylinder which specifies the 3D viewing space surrounding the viewer (or user).

Syntax

aligned(8) class ViewingSpaceBox extends FullBox(‘vssn’,
0, flags) {

CylinderStruct( );

}

In one example, according to the techniques described herein, data encapsulator 107 may be configured to signal viewing space information of a conical frustum space based on the following example definition, syntax, and semantics:

### Definition

The conical frustum space structure (ConicalFrustumStruct) specifies information about a Conical frustum.

Syntax

aligned(8) class ConicalFrustum ( ) {

unsigned int (32) radius0;
unsigned int (32) radius1;
Point(0);
Point(1);

}
aligned(8) class Point(i) {

unsigned int (32) x[i];

unsigned int (32) y[i];
unsigned int (32) z[i];
}

Semantics

radius0, radius1 respectively specify the radii of a conical frustum in 3D space in suitable units with the conical frustum formed around the line from Point(0) to Point(1). Value 0 is reserved.

X[i], y[i] and z[i] is a value in suitable units that specifies the X, Y, Z co-ordinates of a Point in 3D space with (0,0,0) as the center of the global co-ordinate system.

In one example, the above information may correspond to a local co-ordinate system. In a variant example the above information may correspond to a global co-ordinate system. In one example, the above information may correspond to some common reference coordinate system. For example, the common reference coordinate system may be common to multiple viewpoints. In one example, for the semantics above suitable units may be meters. In one example, for the semantics above the suitable units may be centimeters. In one example, for the semantics above the suitable units may be millimeters. In one example, for the semantics above the “suitable units” may be in a “scale” which is signaled.

In one example, according to the techniques described herein, data encapsulator 107 may be configured to signal viewing space information of a conical frustum space based on the following example syntax and semantics:

Syntax

aligned(8) class ConicalFrustum(scale) {

unsigned int (32) radius0;
unsigned int (32) radius1;
Point(0);
Point(1);

}

### Semantics

radius0, radius1 respectively specify the radii of a conical frustum in 3D space in suitable units, where scale specifies number of units in one centimeter, with the conical frustum formed around the line from Point(0) to Point(1). Value 0 is reserved.

In one example, according to the techniques described herein, data encapsulator 107 may be configured to signal viewing space information of a conical frustum space based on the following example syntax and semantics:

Syntax

aligned(8) class ConicalFrustum( ) {

unsigned int (16) scale;
unsigned int (32) radius0;
unsigned int (32) radius1;
Point(0);
Point(1);

}

Semantics

scale specifies how many units correspond to 1 centimeter.

radius0, radius1 respectively specify the radii of a conical frustum in 3D space in suitable units, where scale specifies number of units in one centimeter, with the conical frustum formed around the line from Point(0) to Point(1). Value 0 is reserved.

x[i], y[i] and z[i] is a value in suitable units that specifies the X, Y, Z co-ordinates of a Point in 3D space with (0,0,0) as the center of the global co-ordinate system.

In one example, a guard range radius value may be signaled in the ConicalFrustum. The guard range space may correspond to a 3D space where the immersive VR experience is provided, but is not guaranteed to be optimal. Thus, the immersive VR experience may degrade gracefully in the guard range space. In one example, when a guard range radius value is allowed to be signaled in the ConicalFrustum, data encapsulator 107 may be configured to signal viewing space information of a conical frustum based on the following example syntax and semantics:

Syntax

aligned(8) class ConicalFrustum(scale) {

```
  unsigned int (32) radius0;
  unsigned int (32) radius1;
  Point(0);
  Point(1);
  bit (1) guard_range_presence_flag;
  bit (7) reserved;
  if(guard_range_presence_flag) {
```

unsigned int (16) guard_radius_diff0;
unsigned int (16) guard_radius_diff1;

}

}

### Semantics

guard_range_presence_flag equal to 1 indicates that the information about guard range space is signaled via guard_radius_diff0, guard_radius_diff1. guard_presence_flag equal to 0 indicates that the information about guard range space is not signaled and the guard range space may or may not be present.

guard_radius_diff0, guard_radius_diff1 are respectively used to specify the thickness of the guard range space which is a conical frustum shell.

The guard range space corresponds to a conical frustum shell between outer conical frustum defined by {Point(0), radius0} and {Point(1), radius1} and inner conical frustum defined by {Point(0), (radius0-guard_radius_diff0)} and {Point(1), (radius1-guard_radius_diff1)}. guard_radius_diff0 shall be less than radius0. guard_radius_diff1 shall be less than radius1. guard_radius_diff0 and guard_radius_diff1 both equal to 0 indicates that the guard range space is not present and immersive VR experience is guaranteed in the conical frustum defined by {Point(0), radius0} and {Point(1), radius1}.

In one example, guard_radius_diff0 and/or guard_radius_diff1 may be signaled as a percentage of radius0 and/or radius1.

In one example, guard_range_presence_flag may not be signaled and guard_radius_diff0 and guard_radius_diff1 may be always signaled. In one example this may be done when guard_radius_diff0 is signaled as a percentage of radius0 and guard_radius_diff0 is signaled as a percentage of radius1. In this case, the value 0 for both guard_radius_diff0 and guard_radius_diff1 can indicate that the guard range space is not present and this signaling can save 8-bits. In one example, in this case, data encapsulator 107 may be configured to signal viewing space information of a conical frustum based on the following example syntax and semantics:

Syntax

aligned(8) class ConicalFrustum( ) {

unsigned int (32) radius0;
unsigned int (32) radius1;
Point(0);
Point(1);
unsigned int (16) guard_radius_diff0;
unsigned int (16) guard_radius_diff1;

}

### Semantics

guard_radius_diff0, guard_radius_diff1 are respectively used to specify the thickness of the guard range space which is a conical frustum shell as a percentage of the radius0 and radius1 respectively.

guard_radius_diff0 and guard_radius_diff1 both equal to 0 indicates that the guard range space is not present and immersive VR experience is guaranteed in the conical frustum defined by {Point(0), radius0} and {Point(1), radius1}.

guard_radius_diff0 and guard_radius_diff1 both shall be in the range of 0 to 100. Value 101 to 255 are reserved.

In another example, special values may be defined for guard_radius_diff0 and guard_radius_diff1 as follows:

guard_radius_diff0 and guard_radius_diff1 are respectively used to specify the thickness of the guard range space which is a conical frustum shell as a percentage of the radius0 and radius1 respectively. guard_radius_diff0 and guard_radius_diff1 both equal to 0 indicates that the guard range space is not present and immersive VR experience is guaranteed in the conical frustum defined by Point(0), Point(1), and radius. guard_radius_diff0 and guard_radius_diff1 both equal to 101 indicates that the guard range space may or may not be present and information about the gurad range space is not signalled. guard_radius_diff0 and guard_radius_diff1 both shall be in the range of 0 to 101. Value 102 to 255 are reserved.

In one example, additionally the syntax element scale may be signaled along with the guard range space related syntax elements in the ConicalFrustum( ) structure. In one example, the conical frustum may be required to be constrained such that the axis of conical frustum is parallel to one of the co-ordinate axis. As an example, the axis of the conical frustum may be required to be parallel to X axis. As an example, the axis of the conical frustum may be required to be parallel to Y axis. As an example, the axis of the conical frustum may be required to be parallel to Z axis. As an example, one or more of the following constraints may be added:

It is a requirement of the bitstream conformance that x[0] shall be equal to x[1].

It is a requirement of the bitstream conformance that y[0] shall be equal to y[1].

It is a requirement of the bitstream conformance that z[0] shall be equal to z[1].

Data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

{Point(0), radius0} and {Point(1), radius1} in this box in the ConicalFrustum( ) specifies the conical frustum which specifies the 3D viewing space surrounding the viewer (or user).

Syntax

aligned(8) class ViewingSpaceBox extends
FullBox(‘vssn’, 0, flags) {
ConicalFrustum( );
}

In one example, data encapsulator 107 may be configured to signal viewing space shape type and conditionally signal viewing space information based on the viewing space shape type. In one example the following syntax and semantics may be used:

Syntax

aligned(8) class ViewingSpaceStruct( ) {

unsigned int (8) viewing_space_shape_type;
if(viewing_space_shape_type==0)

VRBB(0);

else if(viewing_space_shape_type==1)

SphereStruct( );

}

Semantics

viewing_space_shape_type specifies the shape of the viewing space. viewing_space_shape_type equal to 0 specifies that the viewing space is specified as a cuboid. viewing_space_shape_type equal to 1 specifies that the viewing space is specified as a sphere. viewing_space_shape_type values greater than 1 are reserved.

In one example, the following syntax and semantics may be used:

Syntax

aligned(8) class ViewingSpaceStruct( ) {

unsigned int (8) viewing_space_shape_type;
if(viewing_space_shape_type==0)

VRBB(0);

else if(viewing_space_shape_type==1)

EllipsoidStruct( );

}

### Semantics

viewing_space_shape_type specifies the shape of the viewing space.
viewing_space_shape_type equal to 0 specifies that the viewing space is specified as a cuboid. viewing_space_shape_type equal to 1 specifies that the viewing space is specified as an ellipsoid. viewing_space_shape_type values greater than 1 are reserved.

In one example, the following syntax and semantics may be used:

Syntax

aligned(8) class ViewingSpaceStruct( ) {

unsigned int (8) viewing_space_shape_type;
if(viewing_space_shape_type==0)

VRBB( );

else if(viewing_space_shape_type==1)

SphereStruct( );

else if(viewing_space_shape_type==2)

EllipsoidStruct( );

}

Semantics

viewing_space_shape_type specifies the shape of the viewing space.

viewing_space_shape_type equal to 0 specifies that the viewing space is specified as a cuboid. viewing_space_shape_type equal to 1 specifies that the viewing space is specified as a sphere. viewing_space_shape_type equal to 2 specifies that the viewing space is specified as a ellipsoid. viewing_space_shape_type values greater than 2 are reserved.

Data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

The VRBB( ) bounding box or SphereStruct( ) or EllipsoidStruct( ) specifies the 3D viewing space surrounding the viewer (or user).

Syntax

aligned(8) class ViewingSpaceBox extends
FullBox(‘vssn’, 0, flags) {

ViewingSpaceStruct( );

}

In one example, one or more excluded regions may have shape of a sphere and may be signalled using SphereStruct( ). In this case, one or more instances of VRBB(i) in the syntax below may be replaced by SphereStruct (or SphereStruct (i). In one example, one or more excluded regions may have shape of an ellipsoid and may be signalled using EllipsoidStruct( ). In this case, one or more instances of VRBB(i) in the syntax below may be replaced by EllipsoidStruct( ) or EllipsoidStruct(i). In one example, the shape of the excluded regions may match the shape of overall viewing space. For example, if the overall viewing space has a shape of the cuboid, then the excluded regions in it may have the shape of a cuboid. In another example, the shape of excluded regions may be different than the shape of overall viewing space. For example, if the overall viewing space has a shape of the sphere the excluded regions in it may have the shape of a cuboid.

In one example, data encapsulator 107 may be configured to signal viewing space shape type and conditionally signal viewing space information based on the viewing space shape type. In one example, the following syntax and semantics may be used:

Syntax

aligned(8) class ViewingSpaceStruct( ) {

unsigned int (8) viewing_space_shape_type;
if(viewing_space_shape_type==0)

VRBB(0);

else if(viewing_space_shape_type==1)

SphereStruct( );

else if(viewing_space_shape_type==2)

CylinderStruct( );

else if(viewing_space_shape_type==3)

ConicalFrustumStruct( );

}

Semantics

viewing_space_shape_type specifies the shape of the viewing space.

viewing_space_shape_type equal to 0 specifies that the viewing space is specified as a cuboid. viewing_space_shape_type equal to 1 specifies that the viewing space is specified as a sphere. viewing_space_shape_type equal to 2 specifies that the viewing space is specified as a cylinder. viewing_space_shape_type equal to 3 specifies that the viewing space is specified as a conical frustum. viewing_space_shape_type values greater than 3 are reserved.

In one example, data encapsulator 107 may be configured to signal viewing space shape type and conditionally signal viewing space information based on the following syntax and semantics:

Syntax

aligned(8) class ViewingSpaceStruct( ) {

unsigned int (8) viewing_space_shape_type;
if(viewing_space_shape_type==0)

VRBB(0);

else if(viewing_space_shape_type==1)

EllipsoidStruct( );

else if(viewing_space_shape_type==2)

CylinderStruct( );

else if(viewing_space_shape_type==3)

ConicalFrustumStruct( );

}

### Semantics

viewing_space_shape_type specifies the shape of the viewing space.
viewing_space_shape_type equal to 0 specifies that the viewing space is specified as a cuboid. viewing_space_shape_type equal to 1 specifies that the viewing space is specified as an ellipsoid. viewing_space_shape_type equal to 2 specifies that the viewing space is specified as a cylinder. viewing_space_shape_type equal to 3 specifies that the viewing space is specified as a conical frustum. viewing_space_shape_type values greater than 3 are reserved.

In one example, data encapsulator 107 may be configured to signal viewing space shape type and conditionally signal viewing space information based on the following syntax and semantics:

Syntax

aligned(8) class ViewingSpaceStruct( ) {

unsigned int (8) viewing_space_shape_type;
if(viewing_space_shape_type==0)

VRBB( );

else if(viewing_space_shape_type==1)

SphereStruct( );

else if(viewing_space_shape_type==2)

EllipsoidStruct( ),

else if(viewing_space_shape_type==3)

CylinderStruct( );

else if(viewing_space_shape_type==4)

ConicalFrustumStruct( );

}

Semantics

viewing_space_shape_type specifies the shape of the viewing space.

viewing_space_shape_type equal to 0 specifies that the viewing space is specified as a cuboid. viewing-space-shape_type equal to 1 specifies that the viewing space is specified as a sphere. viewing_space_shape_type equal to 2 specifies that the viewing space is specified as a ellipsoid. viewing_space_shape_type equal to 3 specifies that the viewing space is specified as a cylinder. viewing_space_shape_type equal to 4 specifies that the viewing space is specified as a conical frustum. viewing_space_shape_type values greater than 4 are reserved.

In one example, data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

The VRBB( ) bounding box or SphereStruct( ) or EllipsoidStruct( ) or CylinderStruct( ) specifies the 3D viewing space surrounding the viewer (or user).

Syntax

aligned(8) class ViewingSpaceBox extends
FullBox(‘vssn’, 0, flags) {

ViewingSpaceStruct( );

}

In an example one or more excluded regions may have shape of a sphere and may be signaled using SphereStruct( ). In this case, one or more instances of VRBB(i) in the syntax below may be replaced by SphereStruct ( ) or SphereStruct (i). In an example, one or more excluded regions may have shape of a ellipsoid and may be signalled using EllipsoidStruct( ). In this case, one or more instances of VRBB(i) in the syntax below may be replaced by EllipsoidStruct( ) or EllipsoidStruct(i). In one example, the shape of the excluded regions may match the shape of overall viewing space. For example, of the overall viewing space has a shape of the cuboid then the excluded regions in it may have the shape of a cuboid. In another example, the shape of excluded regions may be different than the shape of overall viewing space. For example, of the overall viewing space has a shape of the sphere the excluded regions in it may have the shape of a cuboid. In one example, the conical frustum may be a cone shape instead. In this case, one of the radius radius0, radius1 may be zero and thus not signaled. Also, in this case, one or more occurrences of “conical frustum” above may be replaced with “cone” or “conical”. Also, in this case, the ConicalFrustum( ) may be replaced by Cone( ).

In one example, data encapsulator 107 may be configured to signal viewing space shape type and conditionally signal viewing space information based on the viewing space shape type. In one example the following syntax and semantics may be used:

Syntax

aligned(8) class ViewingSpaceStruct(i) {

unsigned int(8) viewing_space_shape_type;
unsigned int(16) distance_scale;
if(viewing_space_shape_type==0){
VRBB(i)
}

else if(viewing_space_shape_type==1)

SphereStruct( );

else if(viewing_space_shape_type==2)

CylinderStruct( );

else if(viewing_space_shape_type==3)

EllipsoidStruct( );

}
aligned(8) class VRBB(i) {

signed int(32) xMin[i];
signed int(32) xMax[i];
signed int(32) yMin[i];
signed int(32) yMax[i];
signed int(32) zMin[i];
signed int(32) zMax[i];

}

aligned(8) SphereStruct( ) {

```
  unsigned int (32) radius;
  }
```

aligned(8) class CylinderStruct( ) {

```
  unsigned int (32) cylinder_radius;
  Point(0);
  Point(1);
```

```
  }
  aligned(8) class Point(i) {
```

```
  signed int(32) x[i];
  signed int(32) y[i];
  signed int(32) z[i];
```

```
  }
  aligned(8) class EllipsoidStruct( ) {
```

```
  unsigned int (32) lengthX;
  unsigned int (32) lengthY;
  unsigned int (32) lengthZ;
```

}

### Semantics

viewing_space_shape_type specifies the shape of the viewing space.
viewing-space-shape_type equal to 0 specifies that the viewing space is specified as a cuboid. viewing_space_shape_type equal to 1 specifies that the viewing space is specified as a sphere. viewing_space_shape_type equal to 2 specifies that the viewing space is specified as a cylinder. viewing_space_shape_type equal to 3 specifies that the viewing space is specified as an ellipsoid.

distance_scale is a positive integer value which indicates the units corresponding to 1 cm.

radius specifies the radius of a sphere as a 16.16 fixed-point value in 3D space in distance scale. Value 0 is reserved.

cylinder_radius specifies the radius of a cylinder in 3D space in suitable units with the cylinder formed around the line from Point(0) to Point(1). Value 0 is reserved.

x[i], y[i] and z[i] is a value in units of distance scale that specifies the X, Y, Z coordinates of a Point in 3D space with respect to the center point of the viewing space.

lengthX, lengthY, and lengthZ specify respectively the semi-axes lengths of X, Y and Z axis of an ellipsoid which has the same center as the viewing space, in units of 2¹⁶ millimeters. lengthX, lengthY, and lengthZ shall be in the ranges of 1 to 65 536*2¹⁶
1 (i.e., 4 294 967 295), inclusive.

When viewpoint position information is present, the center position of the viewing space is equal to the position of the viewpoint. When viewpoint position information is not present, the center position of the viewing space is equal to (0,0,0) in the common reference coordinate system. In both cases, the X,Y,Z coordinate axis are aligned with the reference global coordinate axis.

In one example, data encapsulator 107 may be configured to signal position information according to a file format position box having the following example definition and syntax:

### Definition

Box Type: ‘vssn’

Container: ProjectedOmniVideoBox

Mandatory: No

Quantity: Zero or one

The fields in this box specify 3D viewing space within which an immersive VR experience is provided.

Syntax

aligned(8) class ViewingSpaceBox extends
FullBox(‘vssn’, 0, flags) {

ViewingSpaceStruct(0);
}

Semantics

VRBB(0) specifies the bounding box (X, Y, Z) minimum and maximum co-ordinates which specify the 3D viewing space within an immersive VR experience is supported.

In one example, according to the techniques described herein, data encapsulator 107 may be configured to signal an immersive experience space. For example, data encapsulator 107 may be configured to signal immersive VR boundaries based on the following example definition, syntax, and semantics:

### Definition

The Immersive VR viewing space timed metadata track indicates the VR viewing space boundaries where immersive experience is supported. The space can be static or can change dynamically on sample basis.

Syntax and Semantics

The track sample entry type ‘vrsp’ shall be used. The sample entry is specified as follows:

class VRSpaceSampleEntry(type) extends
MetadataSampleEntry(‘vrsp’) {

unsigned int(1) static_vr_space_flag;

if (static_vr_space_flag == 1) {

ViewingSpaceStruct(0);

}

}

static_vr_space_flag equal to 1 specifies that the immersive VR experience viewing space does not change for each sample referring to this sample entry.

static_vr_space_flag equal to 0 specifies that the immersive 3D VR space may change for samples referring to this sample entry.

VRBB(0) in the sample entry specifies the bounding box (X, Y, Z) minimum and maximum co-ordinates which specify the 3D space within an immersive VR experience is supported.

The sample syntax shown in VRSpaceSample shall be used.

aligned(8) VRSpaceSample( ) {

if(static_vr_space_flag == 0)

ViewingSpaceStruct(0);

}

VRBB(0) in the sample specifies the bounding box (X, Y, Z) minimum and maximum co-ordinates which specify the 3D space within an immersive VR experience is supported for the associated media track samples.

MPEG-I specifies how to encapsulate, signal, and stream omnidirectional media using dynamic adaptive streaming over MPEG media transport. MMT is described in ISO/IEC: ISO/IEC 23008-1, “Information technology-High efficiency coding and media delivery in heterogeneous environments-Part 1: MPEG media transport (MMT),” which is incorporated by reference herein in its entirety. In the case where MMT is used for streaming video data, video data may be encapsulated in a Media Processing Unit (MPU). MMT defines a MPU as “a media data item that may be processed by an MMT entity and consumed by the presentation engine independently from other MPUs.” A logical grouping of MPUs may form an MMT asset, where MMT defines an asset as “any multimedia data to be used for building a multimedia presentation. An asset is a logical grouping of MPUs that share the same asset identifier for carrying encoded media data.” One or more assets may form a MMT package, where a MMT package is a logical collection of multimedia content. As provided in ISO/IEC 23008-1, MMT content is composed of Media Fragment Units (MFU), MPUs, MMT assets, and MMT packages. In order to produce MMT content, encoded media data is decomposed into MFUs, where MFUs may correspond to access units or slices of encoded video data or other units, which can be independently decoded. One or more MFUs may be combined into a MPU. In addition to including one or more assets, a MMT package includes presentation information (PI) and asset delivery characteristics (ADC). Presentation information includes documents (PI documents) that specify the spatial and temporal relationship among the assets. In some cases, a PI document may be used to determine the delivery order of assets in a package. A PI document may be delivered as one or more signaling messages. Signaling messages may include one or more tables. Asset delivery characteristics describe the quality of service (QoS) requirements and statistics of assets for delivery.

MPEG-I provides a VR Information Asset descriptor which is used to inform the receiving entity and the VR application about the content of the current Asset that carries VR content. The information describes the projection type that is used, how the VR content is region-wise frame packed, and what areas on the sphere it covers. The indication if content is stereoscopic with frame packing is provided through a separate Asset descriptor. Table 1 provides the syntax for the VR Information Asset descriptor in MPEG-I. In Table 1 and other Tables herein mnemonic uimsbf corresponds to unsigned integer, most significant bit first and mnemonic bslbf corresponds to bit string, left bit first.

TABLE 1

| | | No. | |
|---|---|---|---|
| | | of | |
| Syntax | Value | bits | Mnemonic |
| VR_information_descriptor( ) { | | | |
| descriptor_tag | | 16 | uimsbf |
| descriptor_length | | 8 | uimsbf |
| rwfp_flag | | 1 | bslbf |
| srqr_flag | | 1 | bslbf |
| 2dqr_flag | | 1 | bslbf |
| reserved | ‘11 1111’ | 5 | bslbf |
| ProjectionFormatStruct( ) | | | |
| InitialViewingOrientationSample( ) | | | |
| ContentCoverageStruct( ) | | | |
| if(rwfp_flag == 1) { | | | |

RegionWisePackingStruct( )

```
  }
  if(srqr_flag == 1) {
```

SphereRegionQualityRankingBox( )

```
  }
  if(2dqr_flag == 1) {
```

2DRegionQualityRankingBox( )

}
}

With respect to Table 1 MPEG-I provides the following semantics:

descriptor_tag indicates the type of a descriptor.

descriptor_length specifies the length in bytes counting from the next byte after this field to the last byte of the descriptor.

rwfp_flag equal to 1 indicates that region-wise frame packing has been applied to the content of this Asset and that the RegionWisePackingStruct that describes it is present.

srqr_flag equal to 1 indicates that sphere region quality information is present.

2dqr_flag equal to 1 indicates that 2D region quality information is present.

ProjectionFormatStruct( ) provides information on the projection format that is used.

InitialViewingOrientationSample( ) provides information about the current initial viewing orientation.

ContentCoverageStruct( ) indicates the sphere region(s) covered by the track.

RegionWisePackingStruct( ) indicates that the projected pictures are packed region-wise and require unpacking prior to rendering, according to the region-wise packing process information as indicated.

SphereRegionQualityRankingBox( ) indicates a relative quality order of quality ranking sphere regions.

2DRegionQualityRankingBox( ) indicates a relative quality order of quality ranking 2D regions.

It should be noted that the VR Information Asset descriptor in MPEG-I fails to provide viewing space information. In one example, according to the techniques described herein, data encapsulator 107 may be configured to signal a VR Information Asset descriptor which conditionally includes viewing space information. Signaling a VR Information Asset descriptor which conditionally includes viewing space information enables more information to be provided to a receiving entity. A receiving entity which is provided more information may have increased functionality. In one example, according to the techniques described herein, data encapsulator 107 may be configured to signal a VR Information Asset descriptor based on the following example syntax in Table 2.

TABLE 2

| | | No. | |
|---|---|---|---|
| | | of | |
| Syntax | Value | bits | Mnemonic |
| VR_information_descriptor( ) { | | | |
| descriptor_tag | | 16 | uimsbf |
| descriptor_length | | 8 | uimsbf |
| rwfp_flag | | 1 | bslbf |
| srqr_flag | | 1 | bslbf |
| 2dqr_flag | | 1 | bslbf |
| viewingspace_info_flag | | 1 | bslbf |
| reserved | ‘1 1111’ | 4 | bslbf |
| ProjectionFormatStruct( ) | | | |
| InitialViewingOrientationSample( ) | | | |
| ContentCoverageStruct( ) | | | |
| if(rwfp_flag == 1) { | | | |

RegionWisePackingStruct( )

```
  }
  if(srqr_flag == 1) {
```

SphereRegionQualityRankingBox( )

```
  }
  if(2dqr_flag == 1) {
```

2DRegionQualityRankingBox( )

```
  }
  if(viewingspace_info_flag == 1) {
```

ViewingSpaceStruct( )

}
}

With respect to Table 2, the following semantics may be used:
descriptor_tag indicates the type of a descriptor.

descriptor_length specifies the length in bytes counting from the next byte after this field to the last byte of the descriptor.

rwfp_flag equal to 1 indicates that region-wise frame packing has been applied to the content of this Asset and that the RegionWisePackingStruct that describes it is present.

srqr_flag equal to 1 indicates that sphere region quality information is present.

2dqr_flag equal to 1 indicates that 2D region quality information is present.

Viewingspacejinfo_flag equal to 1 indicates that viewing space information as specified by ViewingSpaceStruct( ) is present in this VR_information_descriptor( ). Viewingspace_info_flag equal to 0 indicates that viewing space information as specified by ViewingSpaceStruct( ) is not present in this VR_information_descriptor( ).

ProjectionFormatStruct( ) provides information on the projection format that is used.

InitialViewingOrientationSample( ) provides information about the current initial viewing orientation.

ContentCoverageStruct( ) indicates the sphere region(s) covered by the track.

RegionWisePackingStruct( ) indicates that the projected pictures are packed region-wise and require unpacking prior to rendering, according to the region-wise packing process information as indicated.

SphereRegionQualityRankingBox( ) indicates a relative quality order of quality ranking sphere regions.

2DRegionQualityRankingBox( ) indicates a relative quality order of quality ranking 2D regions.

ViewingSpaceStruct( ) indicates viewing space information. ViewingSpaceStruct( ) may be identical to any of the definitions provided herein.

In this manner, data encapsulator 107 represents an example of a device configured to signal position information and signal an immersive experience space.

Referring again to FIG. 1, interface 108 may include any device configured to receive data generated by data encapsulator 107 and transmit and/or store the data to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, PC, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, PC, or any other logical and physical structure that may be used to interconnect peer devices. Data decapsulator 123 may be configured to receive a bitstream generated by data encapsulator 107 and perform sub-bitstream extraction according to one or more of the techniques described herein.

Video decoder 124 may include any device configured to receive a bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. Display 126 may include a stereoscopic display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein. Destination device 120 may include a receive device.

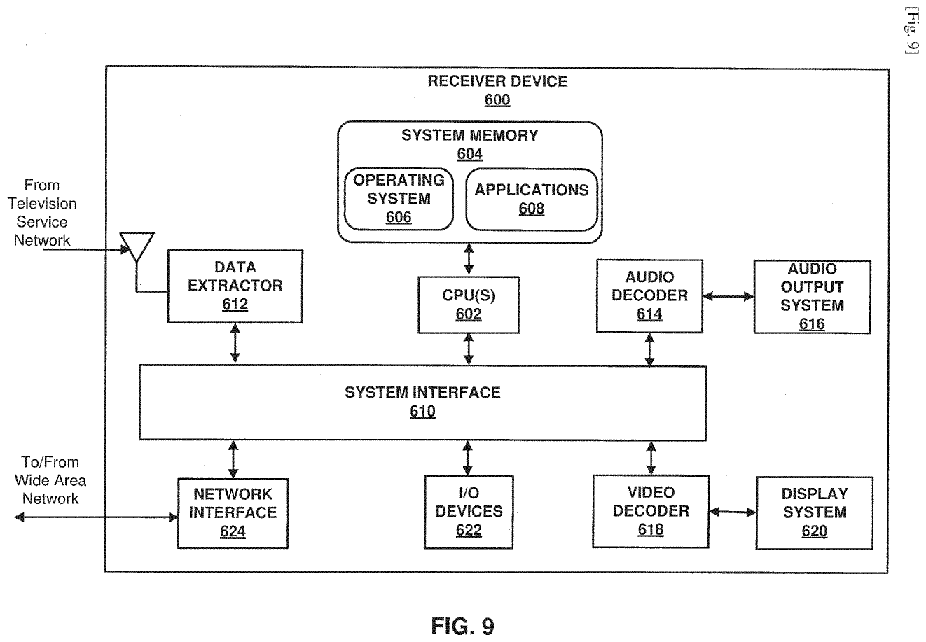

FIG. 9 is a block diagram illustrating an example of a receiver device that may implement one or more techniques of this disclosure. That is, receiver device 600 may be configured to parse a signal based on the semantics described above. Further, receiver device 600 may be configured to operate according to expected play behavior described herein. Further, receiver device 600 may be configured to perform translation techniques described herein. Receiver device 600 is an example of a computing device that may be configured to receive data from a communications network and allow a user to access multimedia content, including a virtual reality application. In the example illustrated in FIG. 9, receiver device 600 is configured to receive data via a television network, such as, for example, television service network 404 described above. Further, in the example illustrated in FIG. 9, receiver device 600 is configured to send and receive data via a wide area network. It should be noted that in other examples, receiver device 600 may be configured to simply receive data through a television service network 404. The techniques described herein may be utilized by devices configured to communicate using any and all combinations of communications networks.

As illustrated in FIG. 9, receiver device 600 includes central processing unit(s) 602, system memory 604, system interface 610, data extractor 612, audio decoder 614, audio output system 616, video decoder 618, display system 620, I/O device(s) 622, and network interface 624. As illustrated in FIG. 9, system memory 604 includes operating system 606 and applications 608. Each of central processing unit(s) 602, system memory 604, system interface 610, data extractor 612, audio decoder 614, audio output system 616, video decoder 618, display system 620, I/O device(s) 622, and network interface 624 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 600 is illustrated as having distinct functional blocks, such an illustration is for descriptive purposes and does not limit receiver device 600 to a particular hardware architecture. Functions of receiver device 600 may be realized using any combination of hardware, firmware and/or software implementations.

CPU(s) 602 may be configured to implement functionality and/or process instructions for execution in receiver device 600. CPU(s) 602 may include single and/or multi-core central processing units. CPU(s) 602 may be capable of retrieving and processing instructions, code, and/or data structures for implementing one or more of the techniques described herein. Instructions may be stored on a computer readable medium, such as system memory 604.

System memory 604 may be described as a non-transitory or tangible computer-readable storage medium. In some examples, system memory 604 may provide temporary and/or long-term storage. In some examples, system memory 604 or portions thereof may be described as non-volatile memory and in other examples portions of system memory 604 may be described as volatile memory. System memory 604 may be configured to store information that may be used by receiver device 600 during operation. System memory 604 may be used to store program instructions for execution by CPU(s) 602 and may be used by programs running on receiver device 600 to temporarily store information during program execution. Further, in the example where receiver device 600 is included as part of a digital video recorder, system memory 604 may be configured to store numerous video files.

Applications 608 may include applications implemented within or executed by receiver device 600 and may be implemented or contained within, operable by, executed by, and/or be operatively/communicatively coupled to components of receiver device 600. Applications 608 may include instructions that may cause CPU(s) 602 of receiver device 600 to perform particular functions. Applications 608 may include algorithms which are expressed in computer programming statements, such as, for-loops, while-loops, if-statements, do-loops, etc. Applications 608 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 600 includes a smart television, applications may be developed by a television manufacturer or a broadcaster. As illustrated in FIG. 9, applications 608 may execute in conjunction with operating system 606. That is, operating system 606 may be configured to facilitate the interaction of applications 608 with CPUs(s) 602, and other hardware components of receiver device 600. Operating system 606 may be an operating system designed to be installed on set-top boxes, digital video recorders, televisions, and the like. It should be noted that techniques described herein may be utilized by devices configured to operate using any and all combinations of software architectures.

System interface 610 may be configured to enable communications between components of receiver device 600. In one example, system interface 610 comprises structures that enable data to be transferred from one peer device to another peer device or to a storage medium. For example, system interface 610 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 600 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 9, data extractor 612 may be configured to extract video, audio, and data from a signal. A signal may be defined according to, for example, aspects DVB standards, ATSC standards, ISDB standards, DTMB standards, DMB standards, and DOCSIS standards.

Data extractor 612 may be configured to extract video, audio, and data, from a signal. That is, data extractor 612 may operate in a reciprocal manner to a service distribution engine. Further, data extractor 612 may be configured to parse link layer packets based on any combination of one or more of the structures described above.

Data packets may be processed by CPU(s) 602, audio decoder 614, and video decoder 618. Audio decoder 614 may be configured to receive and process audio packets. For example, audio decoder 614 may include a combination of hardware and software configured to implement aspects of an audio codec. That is, audio decoder 614 may be configured to receive audio packets and provide audio data to audio output system 616 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 616 may be configured to render audio data. For example, audio output system 616 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 618 may be configured to receive and process video packets. For example, video decoder 618 may include a combination of hardware and software used to implement aspects of a video codec. In one example, video decoder 618 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 Advanced video Coding (AVC)), and High-Efficiency Video Coding (HEVC). Display system 620 may be configured to retrieve and process video data for display. For example, display system 620 may receive pixel data from video decoder 618 and output data for visual presentation. Further, display system 620 may be configured to output graphics in conjunction with video data, e.g., graphical user interfaces. Display system 620 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 622 may be configured to receive input and provide output during operation of receiver device 600. That is, I/O device(s) 622 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 622 may be operatively coupled to receiver device 600 using a standardized communication protocol, such as for example, Universal Serial Bus protocol (USB), Bluetooth, ZigBee or a proprietary communications protocol, such as, for example, a proprietary infrared communications protocol.

Network interface 624 may be configured to enable receiver device 600 to send and receive data via a local area network and/or a wide area network. Network interface 624 may include a network interface card, such as an Ethernet card, an optical transceiver, a radio frequency transceiver, or any other type of device configured to send and receive information. Network interface 624 may be configured to perform physical signaling, addressing, and channel access control according to the physical and Media Access Control (MAC) layers utilized in a network. Receiver device 600 may be configured to parse a signal generated according to any of the techniques described above with respect to FIG. 8. In this manner, receiver device 600 represents an example of a device configured parse one or more syntax elements including information associated with a virtual reality application.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

### CROSS REFERENCE

This Nonprovisional application claims priority under 35 U.S.C. § 119 on provisional Application No. 62/622,701 on Jan. 26, 2018, No. 62/655,156 on Apr. 9, 2018, No. 62/669,828 on May 10, 2018, No. 62/697,240 on Jul. 12, 2018, No. 62/725,145 on Aug. 30, 2018, the entire contents of which are hereby incorporated by reference.

1-7. (canceled)

8: A method of signaling viewing space information for a three-dimensional space, the method comprising:
parsing a radius syntax element specifying a radius of a sphere;
parsing a guard range flag syntax element specifying whether guard range information is present; and
parsing a guard radius difference syntax element, specifying a thickness of a guard range spherical shell, according to a value of the guard range flag syntax element.

9: The method of claim 8, wherein the radius syntax element is coded as a 32-bit unsigned integer.

10: The method of claim 8, wherein the thickness of the guard range spherical shell is a thickness inside a sphere of a radius equal to the radius syntax element as a percentage of the radius syntax element.

11: The method of claim 8, wherein the guard radius difference syntax element is coded as a 7-bit unsigned integer.

12: A method of receiving viewing space information for a three-dimensional space, the method comprising:
parsing a radius syntax element specifying a radius of a sphere;
parsing a guard range flag syntax element specifying whether guard range information is present; and
parsing a guard radius difference syntax element, specifying a thickness of a guard range spherical shell, according to a value of the guard range flag syntax element.

13: A device of signaling viewing space information for a three-dimensional space, the device comprising:
a processor, and
a memory associated with the processor; wherein the processor is configured to perform the following steps:
parsing a radius syntax element specifying a radius of a sphere;
parsing a guard range flag syntax element specifying whether guard range information is present; and
parsing a guard radius difference syntax element, specifying a thickness of a guard range spherical shell, according to a value of the guard range flag syntax element.
